(19) United States
(12) Patent Application Publication
(10) Pub. No.: US 2021/0131069 A1
(43) Pub. Date: May 6, 2021

(54) Hydraulic Drive System for Construction Machine

(71) Applicant: Hitachi Construction Machinery Tierra Co., Ltd., Koka-shi, Shiga (JP)

(72) Inventors: Kiwamu TAKAHASHI, Moriyama-shi (JP); Taihei MAEHARA, Koka-shi (JP); Takeshi ISHII, Gamou-gun, Hino-cho (JP); Yoshifumi TAKEBAYASHI, Koka-shi (JP); Natsuki NAKAMURA, Koka-shi (JP); Daisuke OKA, Yasu-shi (JP)

(21) Appl. No.: 16/492,482

(22) PCT Filed: May 23, 2018
(86) PCT No.: PCT/JP2018/019890

§ 371 Date: Sep. 9, 2019

(30) Foreign Application Priority Data
Sep. 29, 2017 (JP) 2017-191557

(51) Int. Cl. E02F 9/22; E02F 3/42

(52) U.S. Cl. CPC E02F 9/2235; E02F 9/2296; E02F 9/2285; E02F 3/422; E02F 9/2292

(57) ABSTRACT

When a swing motor and a boom cylinder are driven simultaneously, a hydraulic drive system appropriately adjusts a distribution of torques between hydraulic pumps and feeds back a torque actually consumed by the hydraulic pump for actuating the swing motor accurately to the hydraulic pump for actuating the boom cylinder. To that end, when boom raising and swinging are performed simultaneously, the hydraulic drive system corrects an allowable torque of a hydraulic pump 302 that supplies a hydraulic fluid to a swing motor 3c so as to be lowered by a certain ratio, reducing allowable torques of hydraulic pumps 102 and 202 that supply a hydraulic fluid to a boom cylinder 3a by torques consumed by the hydraulic pumps 102 and 202 that supply a hydraulic fluid to the swing motor 3c.

### TECHNICAL FIELD

The present invention relates to a hydraulic drive system for a construction machine such as a hydraulic excavator or the like, and more particularly to a hydraulic drive system that drives a plurality of actuators with a plurality of hydraulic pumps and limits absorption torques of the hydraulic pumps such that the sum of consumption torques of the hydraulic pumps does not exceed a predetermined value, i.e., performs so-called horsepower control.

### BACKGROUND ART

Patent Document 1 discloses an arrangement in which three variable-displacement hydraulic pumps are used and the delivery pressure of the third hydraulic pump is limited by a pressure reducing valve and fed back to regulators of the first and second hydraulic pumps.

Patent Document 2 discloses in its embodiment 1 a controller for a construction machine such as a hydraulic excavator that has a first hydraulic pump for actuating a swing motor and a second hydraulic pump for actuating a work implement including a boom, an arm, and so on. In an independent swing operation mode for independently actuating an upper swing structure, the controller computes an allowable torque of the first hydraulic pump for actuating the swing motor from the magnitude of a swing operation signal. In a combined operation mode for swinging the upper swing structure and raising the boom, the controller computes an allowable torque of the first hydraulic pump for actuating the swing motor from the magnitude of a swing operation signal, and computes an allowable torque of the second hydraulic pump by subtracting the allowable torque of the first hydraulic pump computed as described above from a maximum allowable torque of the second hydraulic pump at the time the upper swing structure is not swung.

### PRIOR ART DOCUMENT

### Patent Documents

Patent Document 1: JP-2002-242904-A
Patent Document 2: JP-2007-247731-A

### SUMMARY OF THE INVENTION

### Problems to be Solved by the Invention

According to the arrangement disclosed in Patent Document 1, since the flow rate of a hydraulic fluid delivered from the third hydraulic pump is controlled by only the delivery pressure of the third hydraulic pump, the hydraulic fluid delivered from the third hydraulic pump that actuates a particular actuator (such as a swing motor) flows at a stable flow rate without being affected by variations of the flow rates of a hydraulic fluid delivered from the first and second hydraulic pumps.

Furthermore, the prime mover for actuating the three hydraulic pumps is prevented from stalling by controlling the sum of torques consumed by the three hydraulic pumps not to exceed a predetermined value, i.e., by performing so-called horsepower control. Moreover, as the third hydraulic pump is of the variable-displacement type and the delivery pressure thereof is fed back to the first and second pumps through the pressure reducing valve, even if the load pressure on the third hydraulic pump is large, the delivery pressure of the third hydraulic pump is limited by the pressure reducing valve. Therefore, the rates of the hydraulic fluid delivered from the first and second hydraulic pumps are not reduced to extremes, and other actuators (a boom, an arm, and so on) than the particular actuator (such as a swing motor) driven by the third hydraulic pump are prevented from suffering an excessive reduction in speed, resulting in good combined operability.

However, the prior art disclosed in Patent Document 1 poses the following problems:

When the swinging and the boom raising are performed simultaneously, the flow rate of the third hydraulic pump that actuates the swing motor is limited by only the load pressure on the swing motor, and the flow rates of the first and second hydraulic pumps that actuate a boom cylinder are limited by the torque consumed by the third hydraulic pump. Consequently, if the third hydraulic pump that actuates the swing motor has a relatively small torque setting, then the good combined operability is achieved as described in Patent Document 1. However, if the third hydraulic pump that actuates the swing motor has a relatively large torque setting, then the torque consumed by the third hydraulic pump is fed back to the first and second hydraulic pumps, greatly lowering the flow rates of the hydraulic fluid supplied from the first and second hydraulic pumps to the boom cylinder. Therefore, the boom raising tends to lag behind the operation of the swing motor, resulting in impaired operability.

According to a specific example, in a task for loading soil scooped up by the bucket onto the cargo bed of a dump truck parked near the hydraulic excavator, the boom raising lags in a manner not intended by the operator, and the bucket is not raised to a height that is enough to exceed the gate of the cargo bed, with the result that the bucket or arm of the hydraulic excavator may hit the gate of the cargo bed.

Using the above arrangement disclosed in Patent Document 2, it is possible to adjust the horsepower ratio of a hydraulic fluid supplied to the work implement and the swing motor based on a swing operation amount and a working operation amount (e.g., a boom raising operation amount), so that the horsepower ratio of the two hydraulic pumps can be adjusted as intended by the operator.

However, the prior art disclosed in Patent Document 2 suffers the following problems:

According to Patent Document 2, as described above, the allowable torque of the hydraulic pump for actuating the swing motor is determined by only the swing operation amount. Actually, however, since the torque that is consumed by the hydraulic pump for actuating the swing motor is determined by an equation proportional to the product of the delivery pressure of the hydraulic pump for actuating the swing motor and the flow rate at the time, the torque that is actually consumed by the hydraulic pump for actuating the swing motor cannot accurately be grasped with the swing operation amount.

For example, even if the swing operation amount is maximum, the load pressure on the swing motor is small providing the swing rotational speed does not increase constantly. According to the prior art disclosed in Patent Document 2, inasmuch as the allowable torque of the hydraulic pump for actuating the swing motor is determined by only the swing operation amount, even if the load pressure on the swing motor is small in the complex operation mode for performing the swinging and the boom raising simultaneously, the allowable torque of the hydraulic pump for actuating the boom cylinder is reduced by the allowable torque of the hydraulic pump for actuating the swing motor. Therefore, the allowable torque of the hydraulic pump for actuating the boom cylinder is likely to be reduced unnecessarily, resulting in a problem that the torque that the prime mover has is not used effectively.

It is an object of the present invention to provide a hydraulic drive system for a construction machine having a plurality of variable-displacement hydraulic pumps and a swing motor and a boom cylinder that are actuated respectively by the different hydraulic pumps, in which the hydraulic drive system performs so-called horsepower control that controls the hydraulic pumps such that the sum of consumption torques of the hydraulic pump for actuating the swing motor and the hydraulic pump for actuating the boom cylinder does not exceed a predetermined value, wherein when the swing motor and the boom cylinder are driven simultaneously, a distribution of torques between the hydraulic pumps can be appropriately adjusted regardless of respective torque settings of the hydraulic pump for actuating the swing motor and the hydraulic pump for actuating the boom cylinder when the swing motor and the boom cylinder are driven independently of each other, and feeds back the torque actually consumed by the hydraulic pump for actuating the swing motor accurately to the hydraulic pump for actuating the boom cylinder, thereby realizing excellent combined operability and effective use of the output torque of a prime mover.

### Means for Solving the Problems

In order to achieve the above object, the present invention provides a hydraulic drive system for a construction machine, the hydraulic drive system comprising: a plurality of hydraulic pumps including variable-displacement first and second hydraulic pumps driven by a prime mover; a plurality of actuators driven by hydraulic fluids delivered from the plurality of hydraulic pumps; a first regulator to which a delivery pressure of the first hydraulic pump is introduced and that controls a displacement volume of the first hydraulic pump such that a torque consumed by the first hydraulic pump does not exceed a first allowable torque; a second regulator to which a delivery pressure of the second hydraulic pump is introduced and that controls a displacement volume of the second hydraulic pump such that a torque consumed by the second hydraulic pump does not exceed a second allowable torque; and a first valve device that generates a first output pressure to feed back the torque consumed by the second hydraulic pump to the first regulator based on the delivery pressure of the second hydraulic pump, wherein the first regulator includes a first operation drive section to which the first output pressure is introduced and with the first operation drive section, the first regulator corrects a horsepower control starting pressure for securing the first allowable torque so as to be smaller by the first output pressure thereby to control the displacement volume of the first hydraulic pump such that a sum of the torques consumed by the first and second hydraulic pumps does not exceed a predetermined value, and the plurality of actuators include a boom cylinder for driving a boom of a front work implement and a swing motor for driving an upper swing structure, the boom cylinder being driven by a hydraulic fluid delivered by the first hydraulic pump, and the swing motor being driven by a hydraulic fluid delivered by the second hydraulic pump, and wherein the hydraulic drive system further comprises: a controller that, when the swing motor and the boom cylinder are driven simultaneously, calculates a correction value for the horsepower control starting pressure for reducing the second allowable torque of the second hydraulic pump so as to be smaller than a maximum allowable torque at a time when the swing motor is driven independently; a second valve device for generating a second output pressure corresponding to the correction value calculated by the controller; a second operation drive section included in the second regulator and to which the second output pressure is introduced for correcting the horsepower control starting pressure for securing the second allowable torque so as to be smaller by the second output pressure; and an output pressure corrector for limiting the first output pressure of the first valve device such that the first output pressure of the first valve device does not exceed the horsepower control starting pressure for securing the second allowable torque corrected by the second operation drive section.

As described above, since the hydraulic drive system includes the first valve device for generating the first output pressure to feed back the torque consumed by the second hydraulic pump to the first regulator based on the delivery pressure of the second hydraulic pump, and corrects the horsepower control starting pressure for securing the first allowable torque so as to be smaller by the first output pressure, it becomes possible to perform so-called horsepower control for controlling the sum of the torques consumed by the second hydraulic pump that drives the swing motor and the first hydraulic pump that drives the boom cylinder so as not to exceed the predetermined value.

Further, since the hydraulic drive system comprises a controller that, when the swing motor and the boom cylinder are driven simultaneously, calculates a correction value for the horsepower control starting pressure for reducing the second allowable torque of the second hydraulic pump so as to be smaller than a maximum allowable torque at a time when the swing motor is driven independently; a second valve device for generating a second output pressure corresponding to the correction value calculated by the controller; and a second operation drive section included in the second regulator and to which the second output pressure is introduced for correcting the horsepower control starting pressure for securing the second allowable torque so as to be smaller by the second output pressure, a distribution of torques between the first and second hydraulic pumps can be appropriately adjusted regardless of respective torque settings of the second hydraulic pump that drives the swing motor and the first hydraulic pump that drives the boom cylinder when the swing motor and the boom cylinder are driven independently of each other. This makes it possible to perform the boom raising speedily when the boom raising and the swinging are performed simultaneously, thereby realizing excellent combined operability.

On the other hand, since the maximum allowable torque of the second hydraulic pump can be set freely without being limited by a torque distribution at the time of a combined swing and boom raising operation, an optimum swing torque is obtained in an independent swing operation for increased swing operability.

Since the hydraulic drive system comprises the output pressure corrector for limiting the first output pressure of the first valve device such that the first output pressure of the first valve device does not exceed the horsepower control starting pressure for securing the second allowable torque corrected by the second operation drive section, even if the delivery pressure of the second hydraulic pump is lower than the limit of the output pressure corrector, the torque actually consumed by the second hydraulic pump that drives the swing motor is accurately fed back to the first hydraulic pump. Thus, the torque consumed by the first hydraulic pump does not be limited unnecessarily, and effective use of the output torque of the prime mover is realized.

### Advantages of the Invention

According to the present invention, so-called horsepower control can be performed for controlling the sum of the torques consumed by the second hydraulic pump that drives the swing motor and the first hydraulic pump that drives the boom cylinder so as not to exceed the predetermined value.

Furthermore, a distribution of torques between the first and second hydraulic pumps can be appropriately set regardless of respective torque settings of the second hydraulic pump that drives the swing motor and the first hydraulic pump that drives the boom cylinder when the swing motor and the boom cylinder are driven independently of each other, thereby realizing excellent combined operability.

On the other hand, maximum allowable torque of the second hydraulic pump can be set freely without being limited by a torque distribution at the time of a combined swing and boom raising operation. Thus, an optimum swing torque is obtained in an independent swing operation for increased swing operability.

Furthermore, since the torque actually consumed by the second hydraulic pump that drives the swing motor is accurately fed back to the hydraulic pump that drives the boom, the torque consumed by the first hydraulic pump does not be limited unnecessarily, and effective use of the output torque of the prime mover is realized.

### BRIEF DESCRIPTION OF THE DRAWINGS

FIG. 1 is a diagram illustrating the configuration of a hydraulic drive system for a construction machine according to a first embodiment of the present invention.

FIG. 2 is a view illustrating the appearance of a hydraulic excavator incorporating the hydraulic drive system according to the present embodiment.

FIG. 3 is a hydraulic circuit diagram illustrating at an enlarged scale a pump periphery portion and a portion regarding torque feedback control in order to assist in an easy understanding of the torque feedback control in a combined operation for swinging and boom raising according to the present embodiment.

FIG. 4 is a functional block diagram illustrating a function regarding the torque feedback control that is performed by a CPU of a controller 50 according to the present embodiment.

FIG. 5A is a diagram illustrating details of a boom raising determining table.

FIG. 5B is a diagram illustrating details of a swing operation correction table.

FIG. 6A is a diagram illustrating changes in an output pressure (second output pressure) of a proportional solenoid valve controlled by the controller.

FIG. 6B is a diagram illustrating output characteristics of a variable pressure reducing valve.

FIG. 7A is a diagram illustrating characteristics of an allowable torque T3allw (second allowable torque) of a variable-displacement main pump (second hydraulic pump).

FIG. 7B is a diagram illustrating characteristics of a torque T3 that is actually consumed by the variable-displacement main pump (second hydraulic pump).

FIG. 7C is a diagram illustrating characteristics of an allowable torque T12allw (first allowable torque) of a variable-displacement main pump (first hydraulic pump).

FIG. 8 is a diagram illustrating characteristics (PQ characteristics) of the delivery pressure and displacement volume of the variable-displacement main pump (second hydraulic pump).

FIG. 9 is a functional block diagram illustrating a function relative to torque feedback control that is performed by a CPU of a controller according to a second embodiment of the present invention.

FIG. 10 is a diagram illustrating details of a swing operation correction table.

FIG. 11A is a diagram illustrating changes in an output pressure ΔP3 of a proportional solenoid valve controlled by the controller.

FIG. 11B is a diagram illustrating output characteristics of a variable pressure reducing valve.

FIG. 12A is a diagram illustrating characteristics of an allowable torque T3allw of a variable-displacement main pump (second hydraulic pump).

FIG. 12B is a diagram illustrating characteristics of a torque T3 that is actually consumed by the variable-displacement main pump (second hydraulic pump).

FIG. 12C is a diagram illustrating characteristics of an allowable torque T12allw of a variable-displacement main pump (first hydraulic pump).

FIG. 13 is a diagram illustrating the configuration of a hydraulic drive system for a construction machine according to a third embodiment of the present invention.

FIG. 14 is a functional block diagram illustrating a function regarding torque feedback control that is performed by a CPU of a controller according to the present embodiment.

### MODES FOR CARRYING OUT THE INVENTION

Embodiments of the present invention will hereinafter be described below with reference to the drawings.

### First Embodiment

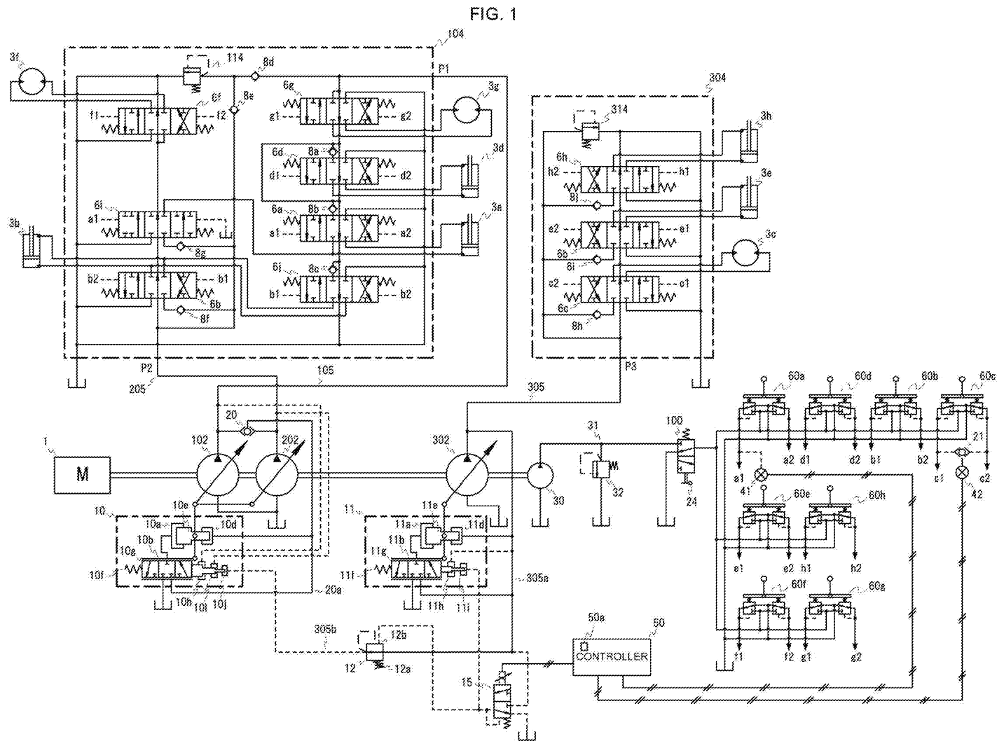

A hydraulic drive system for a construction machine according to a first embodiment of the present invention will be described below with reference to FIGS. 1 through 8.

˜Configuration˜

FIG. 1 is a diagram illustrating the configuration of the hydraulic drive system for the construction machine according to the first embodiment of the present invention.

In FIG. 1, the hydraulic drive system according to the present embodiment includes a prime mover 1 (e.g., a diesel engine), variable-displacement main pumps 102 and 202 (first hydraulic pump) actuated by the prime mover 1, a variable-displacement main pump 302 (second hydraulic pump) actuated by the prime mover 1, a fixed-displacement pilot pump 30 actuated by the prime mover 1, a boom cylinder 3a, an arm cylinder 3b, a bucket cylinder 3d, and track motors 3f and 3g as a plurality of actuators actuated by a hydraulic fluid delivered from the variable-displacement main pumps 102 and 202, a swing motor 3c, a swing cylinder 3e, and a blade cylinder 3h as a plurality of actuators actuated by a hydraulic fluid delivered from the variable-displacement main pump 302, hydraulic fluid supply lines 105 and 205 for guiding a hydraulic fluid delivered from the variable-displacement main pumps 102 and 202 to the actuators 3a, 3b, 3d, 3f, and 3g, a hydraulic fluid supply line 305 for guiding a hydraulic fluid delivered from the variable-displacement main pump 302 to the actuators 3c, 3e, and 3h, a control valve block 104 connected to downstream portions of the hydraulic fluid supply lines 105 and 205 and to which a hydraulic fluid delivered from the variable-displacement main pumps 102 and 202 is introduced, a control valve block 304 connected to a downstream portion of the hydraulic fluid supply line 305 and to which a hydraulic fluid delivered from the variable-displacement main pump 302 is introduced, a common first regulator 10 associated with the variable-displacement main pumps 102 and 202 for controlling the displacement volumes of the main pumps 102 and 202 such that the torques consumed by the main pumps 102 and 202 does not exceed a first allowable torque (T12allw), and a second regulator 11 associated with the variable-displacement main pump 302 for controlling the displacement volume of the main pump 302 such that the torque consumed by the main pump 302 does not exceed a second allowable torque (T3allw).

The control valve block 104 includes a plurality of directional control valves 6a, 6b, 6d, 6f, 6g, 6i, and 6j for controlling the directions in and the speeds at which the actuators 3a, 3b, 3d, 3f, and 3g are driven, and a relief valve 114 connected to the downstream portions of the hydraulic fluid supply lines 105 and 205 respectively through check valves 8d and 8e for controlling the pressures of the hydraulic fluid supply lines 105 and 205 not to reach a preset pressure or higher. In the control valve block 104, a hydraulic fluid is introduced from the downstream portion of the hydraulic fluid supply line 205 to the directional control valves 6b and 6i respectively through check valves 8f and 8g, and a hydraulic fluid is introduced from the downstream portion of the hydraulic fluid supply line 105 to the directional control valves 6d, 6a, and 6j respectively through check valves 8a, 8b, and 8c.

The control valve block 304 includes a plurality of directional control valves 6c, 6e, and 6h for controlling the directions in and the speeds at which the actuators 3c, 3e, and 3h are driven, and a relief valve 314 connected to the downstream portions of the hydraulic fluid supply line 305 for controlling the pressure of the hydraulic fluid supply line 305 not to reach a preset pressure or higher. In the control valve block 304, a hydraulic fluid is introduced from the downstream portion of the hydraulic fluid supply line 305 to the directional control valves 6c, 6e, and 6h respectively through check valves 8h, 8i, and 8j.

The first regulator 10 has a differential piston 10e driven due to the difference between pressure receiving areas thereof and a tilting control valve 10b. The differential piston 10e has a larger-diameter pressure receiving chamber 10a selectively connectable to a hydraulic line 20a or a tank through the tilting control valve 10b and a smaller-diameter pressure receiving chamber 10d connected to the hydraulic line 20a at all times. The output pressure of a shuttle valve 20 that selects a higher one of the pressures of the hydraulic fluid supply lines 105 and 205 (delivery pressures of the main pumps 102 and 202) is introduced to the hydraulic line 20a.

When the larger-diameter pressure receiving chamber 10a is brought into fluid communication with the hydraulic line 20a, the differential piston 10e is shifted to the right in FIG. 1 due to the difference between its pressure receiving areas. When the larger-diameter pressure receiving chamber 10a is brought into fluid communication with the tank, the differential piston 10e is shifted to the left in FIG. 1 due to the force applied from the smaller-diameter pressure receiving chamber 10d. When the differential piston 10e is shifted to the right in FIG. 1, the tilting angles of the variable-displacement main pumps 102 and 202, i.e., the pump displacement volumes thereof, are reduced, reducing the flow rates of the hydraulic fluid delivered therefrom. When the differential piston 10e is shifted to the left in FIG. 1, the tilting angles of the variable-displacement main pumps 102 and 202, i.e., the pump displacement volumes thereof, are increased, increasing the flow rates of the hydraulic fluid delivered therefrom.

The tilting control valve 10b is an input torque limiting valve and is made up of a spool 10g, a spring 10f, and operation drive sections 10h, 10i, and 10j. The hydraulic fluid supply line 105 of the variable-displacement main pump 102 has its pressure P1 introduced to the operation drive section 10h, and the hydraulic fluid supply line 205 of the variable-displacement main pump 202 has its pressure P2 introduced to the operation drive section 10i. The hydraulic fluid supply line 305 of the variable-displacement main pump 302 has its pressure P3 sent through a hydraulic line 305a to a variable pressure reducing valve 12 (first valve device) and reduced by the variable pressure reducing valve 12. A reduced output pressure P3′ (first output pressure) is introduced to a hydraulic line 305b and then introduced therethrough as a correction value for a horsepower control starting pressure for the first regulator 10 to the operation drive section 10j (hereinafter referred to as first operation drive section) of the tilting control valve 10b.

The spring 10f determines a maximum allowable torque T12allw_max for horsepower control for the first regulator 10 and determines a horsepower control starting pressure for securing the maximum allowable torque T12allw_max.

The variable pressure reducing valve 12 is a valve that, when the pressure in the hydraulic line 305a is equal to or higher than a certain value (set pressure) reduces the pressure in the hydraulic line 305a to that value, limiting the first output pressure P3′, the value (set pressure) being variable. The variable pressure reducing valve 12 has a spring 12a for determining a set pressure at the time a combined operation for swinging and boom raising is not performed. The set pressure of the variable pressure reducing valve 12 determines a limiting pressure for the first output pressure P3′ and the spring 12a determines a maximum limiting pressure therefor.

The variable pressure reducing valve 12 also has a pressure receiving section 12b (output pressure corrector) disposed opposite the spring 12a, for reducing the set pressure (limiting pressure) by an output pressure ΔP3 (second output pressure) that is introduced to the pressure receiving section 12b from a proportional solenoid valve 15 (second valve device). If the output pressure ΔP3 that is introduced from the proportional solenoid valve 15 to the pressure receiving section 12b is a tank pressure, then the set pressure of the variable pressure reducing valve 12 is of a maximum value determined by the spring 12a, and the limiting pressure is also maximum. As the output pressure ΔP3 that is introduced from the proportional solenoid valve 15 to the pressure receiving section 12b increases, the set pressure of the variable pressure reducing valve 12 is reduced and the limiting pressure also becomes lower.

The second regulator 11 has a differential piston 11e driven due to the difference between pressure receiving areas thereof and a tilting control valve lib. The differential piston 11e has a larger-diameter pressure receiving chamber 11a selectively connected to the hydraulic line 305a or the tank through the tilting control valve 11b and a smaller-diameter pressure receiving chamber 11d connected to the hydraulic line 305a at all times. The pressure P3 of the hydraulic fluid supply line 305 (delivery pressure of the main pump 302) is introduced to the hydraulic line 305a.

When the larger-diameter pressure receiving chamber 11a is brought into fluid communication with the hydraulic line 305a, the differential piston 11e is shifted to the right in FIG. 1 due to the difference between its pressure receiving areas. When the larger-diameter pressure receiving chamber 11a is brought into fluid communication with the tank, the differential piston 11e is shifted to the left in FIG. 1 due to the force applied from the smaller-diameter pressure receiving chamber 11d. When the differential piston 11e is shifted to the right in FIG. 1, the tilting angle of the variable-displacement main pump 302, i.e., the pump displacement volume thereof, is reduced, reducing the flow rate of the hydraulic fluid delivered therefrom. When the differential piston 11e is shifted to the left in FIG. 1, the tilting angle of the variable-displacement main pump 302, i.e., the pump displacement volume thereof, is increased, increasing the flow rate of the hydraulic fluid delivered therefrom.

The tilting control valve 11b is an input torque limiting valve and is made up of a spool 11g, a spring 11f, and operation drive sections 11h and 11i. The hydraulic fluid supply line 305 of the variable-displacement main pump 302 has its pressure P3 introduced to the operation drive section 11h through the hydraulic line 305a. The output pressure ΔP3 (second output pressure) from the proportional solenoid valve 15 is introduced as a correction value for a horsepower control starting pressure for the second regulator 11 to the operation drive section 11i (hereinafter referred to as second operation drive section) and is also introduced as a correction value for the limiting pressure to the pressure receiving section 12b of the variable pressure reducing valve 12.

The spring 11f determines a maximum allowable torque T3allw_max for horsepower control for the second regulator 11 and determines a horsepower control starting pressure (P3amax to be described later) for securing the maximum allowable torque T3allw_max.

The fixed-displacement pilot pump 30 has a hydraulic fluid supply line 31a to which there is connected a pilot relief valve 32 for keeping the pressure of the hydraulic fluid supply line 31a constant as a constant pilot primary pressure Ppi0 produced therefrom.

A pilot hydraulic line 31b is connected through a gate lock valve 100 to the hydraulic fluid supply line 31a downstream of the pilot relief valve 32. To pilot hydraulic line 31b, there are connected pairs of pilot valves (pressure reducing valves) disposed in a plurality of operation devices 60a, 60b, 60c, 60d, 60e, 60f, 60g, and 60h, respectively. The operation devices 60a, 60b, 60c, 60d, 60e, 60f, 60g, and 60h serve to command respective drives of the corresponding actuators 3a through 3h. When operating means such as operation levers or the like of the operation devices 60a, 60b, 60c, 60d, 60e, 60f, 60g, and 60h are operated, their pilot valves generate operation pressures a1 and a2, b1 and b2, c1 and c2, d1 and d2, e1 and e2, f1 and f2, g1 and g2, and h1 and h2 from a source pressure represented by the pilot primary pressure Ppi0 produced by the pilot relief valve 32. These operation signals are introduced to the corresponding directional control valves 6a through 6j to selectively shift them. When a gate lock lever 24 disposed at the operator seat of the hydraulic excavator (construction machine) is operated, the gate lock valve 100 is operated to selectively supply the pilot primary pressure Ppi0 produced by the pilot relief valve 32 to the pilot hydraulic line 31b (enable the operation devices 60a through 60h) or discharge the hydraulic fluid in the pilot hydraulic line 31b to the tank (disable the operation devices 60a through 60h).

The hydraulic drive system also includes a shuttle valve 21 for selecting and delivering a higher operation pressure ch of operation pressures c1 and c2 that are delivered from the pair of pilot valves of the operation device 60c for the swing motor 3c, among the plurality of operation devices, a pressure sensor 41 for detecting an operation pressure a1 for operating the boom cylinder 3a in a direction to extend (operation pressure for boom raising) of operation pressures a1 and a2 that are delivered from the pair of pilot valves of the operation device 60a for the boom cylinder 3a, and a pressure sensor 42 for detecting the higher operation pressure (swing operation pressure) ch delivered from the shuttle valve 21.

Outputs from the pressure sensors 41 and 42 are introduced to a controller 50, and an output from the controller 50 is introduced to the proportional solenoid valve 15. The pressure sensors 41 and 42 detect the operation pressure a1 and the operation pressure ch thereby to detect operated amounts of the operation levers of the operation devices 60a and 60c. The pressure sensors 41 and 42 may be replaced with potentiometers for directly detecting operated amounts of the operation levers of the operation devices 60a and 60c.

The pressure P3 of the hydraulic line 305a (pressure delivered from the main pump 302) is introduced to the proportional solenoid valve 15 as a source pressure from which the proportional solenoid valve 15 is to generate its output pressure.

˜Torque Feedback Control˜

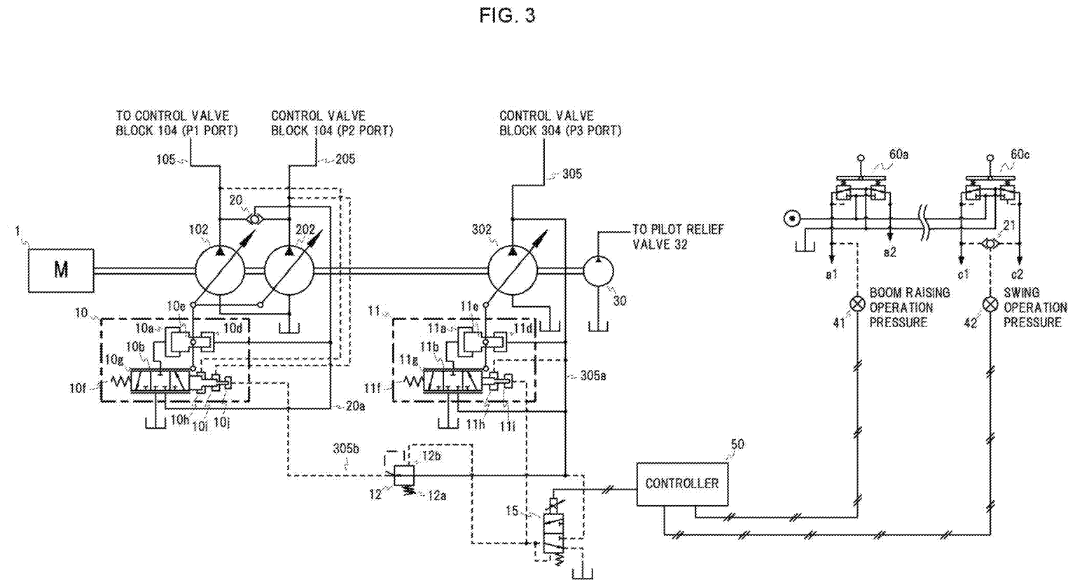

FIG. 3 is a hydraulic circuit diagram illustrating at an enlarged scale a pump periphery portion and a portion regarding torque feedback control in order to assist in an easy understanding of the torque feedback control in a combined operation for swinging and boom raising according to the present embodiment.

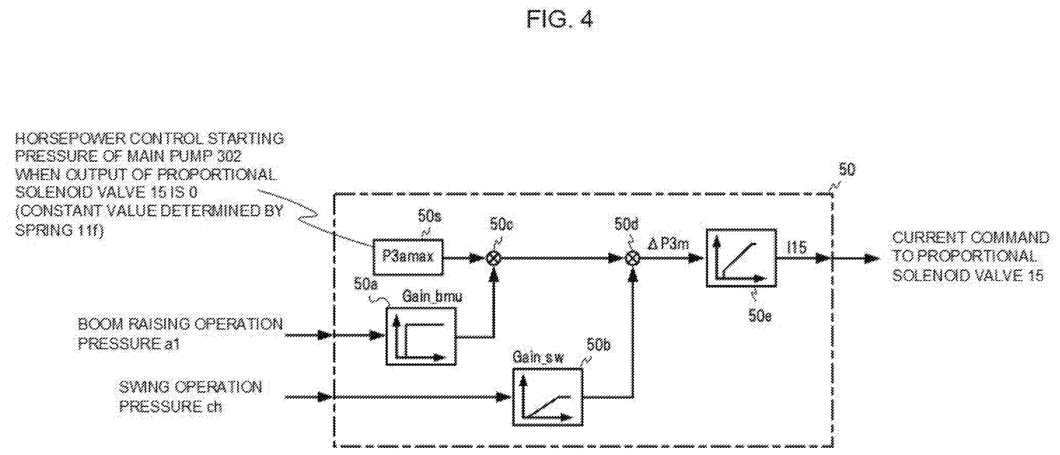

FIG. 4 is a functional block diagram illustrating a function regarding the torque feedback control that is performed by a CPU 50a of the controller 50 according to the present embodiment.

In FIG. 4, the CPU 50a of the controller 50 has functions as a setting block 50s, a boom raising determining table 50a, a swing operation correction table 50b, multipliers 50c and 50d, and a current command calculating table 50e.

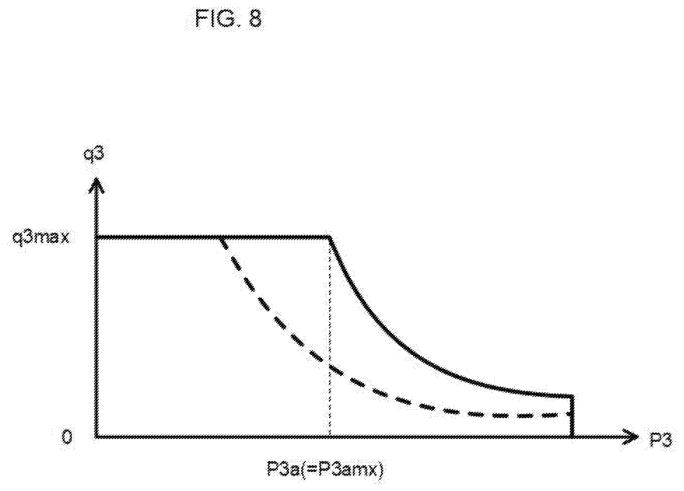

The setting block 50s has set therein a horsepower control starting pressure P3amax (see FIG. 8) for securing the maximum allowable torque T3allw_max for the second regulator 11 at the time when a combined operation for swinging and boom raising is not performed and the output pressure from the proportional solenoid valve 15 is 0.

The operation pressure a1 for boom raising and the swing operation pressure ch that are detected respectively by the pressure sensors 41 and 42 are input respectively to the tables 50a and 50b.

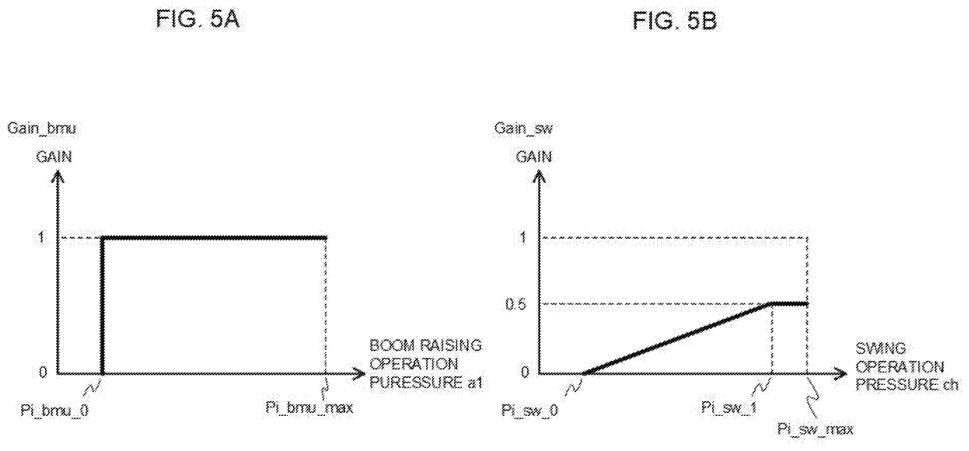

FIGS. 5A and 5B are diagrams illustrating details of the tables 50a and 50b.

In FIG. 5A, the table 50a has set therein characteristics in which when the operation pressure a1 for boom raising is higher than a minimum pressure Pi_bmu_0 in excess of a dead zone, a gain Gain_bmu according to boom raising operation increases from 0 to 1.

In FIG. 5B, the table 50b has set therein characteristics in which when the swing operation pressure ch is higher than a minimum pressure Pi_sw_0 in excess of a dead zone, a gain Gain_sw according to swing operation starts to increase from 0, and when the swing operation pressure ch increases up to a pressure Pi_sw_1 immediately prior to a maximum pressure Pi_sw_max, the gain Gain_sw becomes 0.5.

The multiplier 50c multiplies the horsepower control starting pressure P3amax set in the setting block 50s by the gain Gain_bmu according to boom raising operation that is output from the table 50a. The multiplier 50d then multiplies the product from the multiplier 50c by the gain Gain_sw according to swing operation that is output from the table 50b. The product from the multiplier 50d is computed as a correction value ΔP3m for a horsepower control starting pressure P3a for the second regulator 11.

The correction value ΔP3m computed by the multiplier 50d is input to the table 50e, which converts the correction value ΔP3m into a current command 115 for driving the proportional solenoid valve 15, and the controller 50 then outputs a corresponding current. The proportional solenoid valve 15 is actuated by the output current to produce the output pressure ΔP3 (second output pressure) corresponding to the correction value ΔP3m.

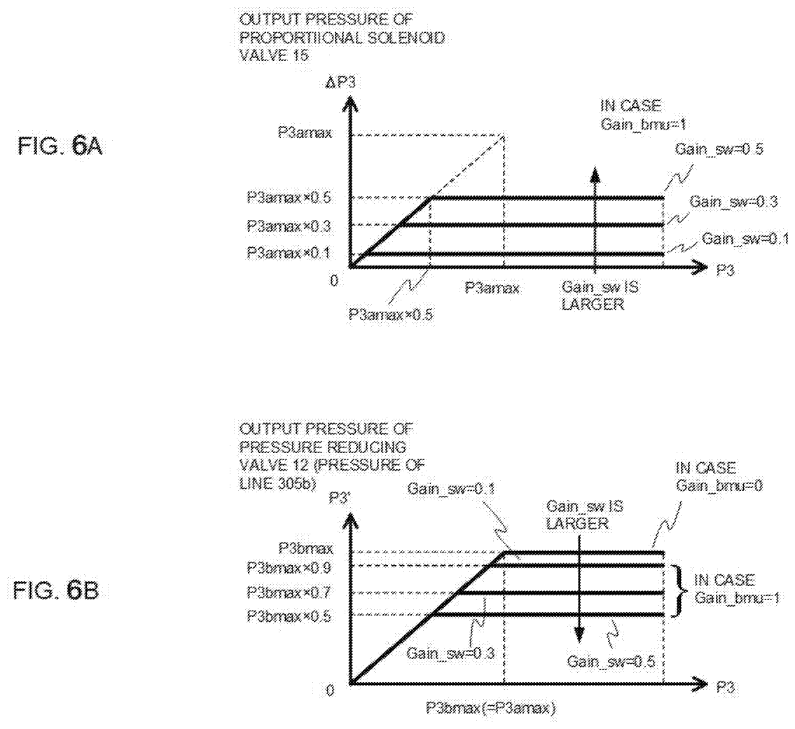

A torque feedback behavior in a combined operation for swinging and boom raising according to the present embodiment will be described below with reference to FIGS. 6A and 6B.

FIG. 6A is a diagram illustrating changes in the output pressure ΔP3 (second output pressure) of the proportional solenoid valve 15 controlled by the controller 50. As illustrated in FIG. 6A, when a combined operation for swinging and boom raising is performed and the gain Gain_bmu according to boom raising operation is Gain_bmu=1, the output pressure ΔP3 is of a value that is larger as the gain Gain_sw according to swing operation is larger. Since the maximum value of the gain Gain_sw according to swing operation is 0.5, the output pressure ΔP3 does not be larger than the horsepower control starting pressure P3amax×0.5 (one half of the horsepower control starting pressure P3amax). The output pressure ΔP3 of the proportional solenoid valve 15 is introduced as a correction value for the horsepower control starting pressure P3a for the second regulator 11 to the second operation drive section 11i of the tilting control valve 11b.

FIG. 6B is a diagram illustrating output characteristics of the variable pressure reducing valve 12. When a combined operation for swinging and boom raising is not performed and the gain Gain_bmu according to boom raising operation is Gain_bmu=0, the output pressure P3′ (first output pressure) of the variable pressure reducing valve 12 increases at a gradient of 1 in a range of 0<P3<P3bmax. P3bmax indicates the set pressure of the spring 12a of the variable pressure reducing valve 12, and a maximum limiting pressure of the variable pressure reducing valve 12. When the pressure P3 of the hydraulic fluid supply line 305 (delivery pressure of the main pump 302) is higher than the set pressure P3bmax of the spring 12a of the variable pressure reducing valve 12, the output pressure P3′ of the variable pressure reducing valve 12 is limited to the set pressure P3bmax.

As described above, the output pressure ΔP3, illustrated in FIG. 6A, of the proportional solenoid valve 15 is introduced as a correction value for the limiting pressure P3b of the variable pressure reducing valve 12 to the pressure receiving section 12b of the variable pressure reducing valve 12. When a combined operation for swinging and boom raising is performed and the gain Gain_bmu according to boom raising operation is Gain_bmu=1, the larger the gain Gain_sw according to swing operation, the smaller the set pressure P3b of the variable pressure reducing valve 12. When the gain Gain_sw becomes 0.5, the set pressure P3b becomes the set pressure P3bmax of the spring 12a×0.5, i.e., one half of the set pressure P3bmax of the spring 12a. Therefore, when the pressure P3 of the hydraulic fluid supply line 305 (delivery pressure of the main pump 302) is higher than the limiting pressure P3b of the variable pressure reducing valve 12, the larger the gain Gain_sw according to swing operation, the smaller the output pressure P3′ of the variable pressure reducing valve 12. When the gain Gain_sw becomes 0.5, the output pressure P3′ is limited to one half of the set pressure P3bmax of the spring 12a. The output pressure P3′ of the variable pressure reducing valve 12 is introduced as a correction value for the horsepower control starting pressure for the first regulator 10 to the first operation drive section 10j of the tilting control valve 10b.

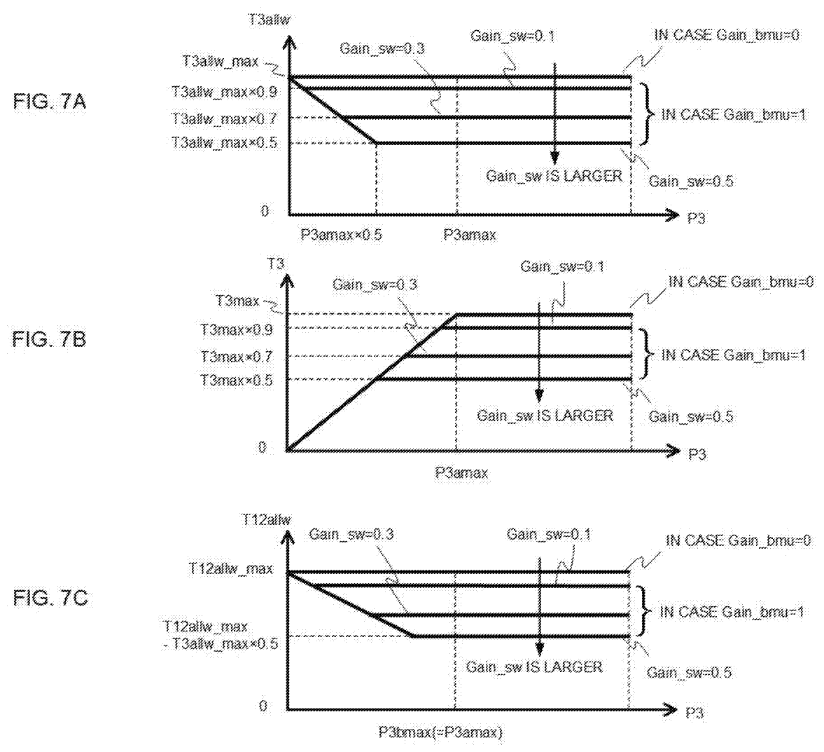

Characteristics of allowable torques of the variable-displacement main pumps 102, 202, and 302 and characteristics of the torque consumed by the main pump 302 will be described below with reference to FIGS. 7A, 7B, and 7C.

FIG. 7A is a diagram illustrating characteristics of the allowable torque T3allw (second allowable torque) of the variable-displacement main pump 302.

In FIG. 7A, T3allw_max represents a maximum allowable torque of the main pump 302 that is determined by the spring 11f. When a combined operation for swinging and boom raising is performed and the gain Gain_bmu according to boom raising operation is Gain_bmu=1, the allowable torque T3allw of the main pump 302 is smaller than the maximum allowable torque T3allw_max, and the larger the gain Gain_sw according to swing operation, the smaller the allowable torque T3allw. At this time, the allowable torque T3allw is reduced to T3allw_max×0.5.

FIG. 7B is a diagram illustrating characteristics of a torque T3 that is actually consumed by the variable-displacement main pump 302.

In FIG. 7B. T3max represents a maximum torque consumed by the main pump 302 that is determined by the maximum allowable torque T3allw_max of the main pump 302. When a combined operation for swinging and boom raising is not performed and the gain Gain_bmu according to boom raising operation is Gain_bmu=0, the torque T3 that is actually consumed by the main pump 302 increases linearly in a range of 0<P3a<P3amax. As illustrated in FIG. 7A, when a combined operation for swinging and boom raising is performed and the gain Gain_bmu according to boom raising operation is Gain_bmu=1, since the allowable torque T3allw of the main pump 302 is smaller than the maximum allowable torque T3allw_max, the torque T3 that is actually consumed by the main pump 302 is smaller than the maximum consumed torque T3max. Furthermore, as illustrated in FIG. 7A, since the larger the gain Gain_sw according to swing operation, the smaller the allowable torque T3allw, the torque T3 that is actually consumed by the main pump 302 is limited by the allowable torque T3allw thereof, and as illustrated in FIG. 7B, the larger the gain Gain_sw according to swing operation, the smaller the torque T3. At this time, the torque T3 is reduced to T3max×0.5 in a manner corresponding to T3allw_max×0.5.

FIG. 7C is a diagram illustrating characteristics of the allowable torque T12allw (first allowable torque) of the variable-displacement main pumps 102 and 202.

The torque T3 that is consumed by the variable-displacement main pump 302 is introduced as the output pressure P3′ (first output pressure) of the variable pressure reducing valve 12 whose characteristics are illustrated in FIG. 6B to the first operation drive section 10j of the tilting control valve 10b, and fed back to the first regulator 10. Therefore, the allowable torque T12allw of the main pumps 102 and 202 has the characteristics illustrated in FIG. 7C.

In FIG. 7C, T12allw_max represents a maximum allowable torque determined by the spring 10f of the first regulator 10, and represents a maximum allowable torque value of the main pumps 102 and 202 in a case in which each of the operation devices of the actuators driven by the variable-displacement main pump 302 is in a neutral operated position.

As illustrated in FIG. 7C, when a combined operation for swinging and boom raising is not performed and the gain Gain_bmu according to boom raising operation is Gain_bmu=0, the allowable torque T12allw of the main pumps 102 and 202 is the maximum allowable torque T12allw_max. When a combined operation for swinging and boom raising is performed and the gain Gain_bmu according to boom raising operation is Gain_bmu=1, the allowable torque T12allw of the main pumps 102 and 202 is of a value smaller than the maximum allowable torque T12allw_max, obtained by subtracting the torque T3 consumed by the main pump 302 from the maximum allowable torque T12allw_max. Furthermore, since the larger the gain Gain_sw according to swing operation, the smaller the torque T3 consumed by the main pump 302, the larger the gain Gain_sw according to swing operation, also the smaller the allowable torque T12allw of the main pumps 102 and 202. At this time, in a manner corresponding to the allowable torque of the main pump 302 being reduced to T3allw_max×0.5 (or the torque consumed by the main pump 302 being reduced to T3max×0.5) the allowable torque T12allw of the main pumps 102 and 202 is reduced to a value obtained by subtracting one half of the maximum allowable torque T3allw_max of the main pump 302 from the maximum allowable torque T12allw_max (T12allw_max−T3allw_max×0.5) or a value obtained by subtracting one half of the maximum torque T3max consumed by the main pump 302 from the maximum allowable torque T12allw_max (T12allw_max−T3max×0.5).

FIG. 8 is a diagram illustrating characteristics, i.e., PQ characteristics, of the delivery pressure and displacement volume of the variable-displacement main pump 302. As illustrated in FIG. 8, the variable-displacement main pump 302 is of such characteristics that it keeps a maximum displacement volume q3max when the delivery pressure P3 is smaller than the horsepower control starting pressure P3a, and has its displacement volume reduced such that the torque consumed by the main pump 302 does not exceed the allowable torque T3allw when the delivery pressure P3 is equal to or larger than the horsepower control starting pressure P3a.

According to the present embodiment, inasmuch as the horsepower control starting pressure P3a is variable and the output pressure of the proportional solenoid valve 15 is 0 when a combined operation for swinging and boom raising is not performed, the horsepower control starting pressure P3a is of a constant value P3amax determined by the spring 11f of the second regulator 11. When a combined operation for swinging and boom raising is performed, as indicated by the broken-line curve in FIG. 8, the horsepower control starting pressure P3a is reduced to one half of P3amax because of the output pressure of the proportional solenoid valve 15. As a result, when a combined operation for swinging and boom raising is not performed, the allowable torque of the main pump 302 is maximum (T3allw_max), and when a combined operation for swinging and boom raising is performed, the allowable torque T3allw of the main pump 302 is reduced to one half of the maximum allowable torque T3allw_max.

˜Correspondence to the Scope of Claims˜

The variable pressure reducing valve 12 serves as a first valve device that generates the first output pressure P3′ to feed back the torque consumed by the main pump 302 to the first regulator 10 based on the delivery pressure of the main pump 302.

The first regulator 10 includes a first operation drive section 10j to which the first output pressure P3′ is introduced, and with the first operation drive section 10j, the first regulator 10 corrects the horsepower control starting pressure for securing the first allowable torque T12allw so as to be smaller by the first output pressure P3′ thereby to control the displacement volumes of the main pumps 102 and 202 (first hydraulic pump) such that the sum of the torques consumed by the main pumps 101 and 202 (first hydraulic pump) and the main pump 302 (second hydraulic pump) does not exceed the predetermined value T12allw_max.

The controller 50 serves as a controller that, when the swing motor 3c and the boom cylinder 3a are driven simultaneously, calculates the correction value ΔP3m for the horsepower control starting pressure for reducing the second allowable torque T3allw of the main pumps 101 and 202 (second hydraulic pump) so as to be smaller than the maximum allowable torque T3allw_max at the time when the swing motor 3c is driven independently.

The proportional solenoid valve 15 serves as a second valve device for generating the second output pressure ΔP3 corresponding to the above correction value ΔP3m calculated by the controller 50.

The second operation drive section 11i is included in the second regulator 11 and to which the second output pressure ΔP3 is introduced for correcting the horsepower control starting pressure P3a for securing the second allowable torque T3allw so as to be smaller by the second output pressure ΔP3.

The pressure receiving section 12b of the variable pressure reducing valve 12 serves as an output pressure corrector for limiting the output pressure P3′ (first output pressure) of the variable pressure reducing valve 12 (first valve device) such that the output pressure P3′ (first output pressure) of the variable pressure reducing valve 12 (first valve device) does not exceed the horsepower control starting pressure P3a for securing the second allowable torque T3allw corrected by the second operation drive section 11i.

˜Hydraulic excavator (construction machine)˜

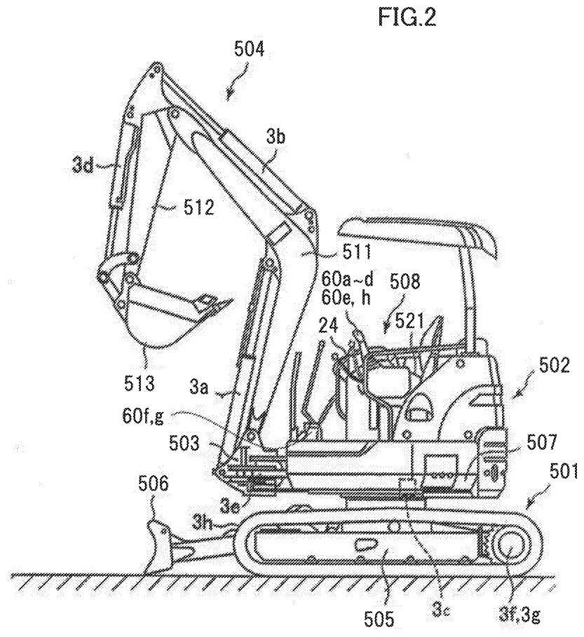

FIG. 2 is a view illustrating the appearance of a hydraulic excavator incorporating the hydraulic drive system according to the present embodiment.

The hydraulic excavator includes a lower track structure 501, an upper swing structure 502, and a swingable front work implement 504. The front work implement 504 is made up of a boom 511, an arm 512, and a bucket 513. The upper swing structure 502 is swingable with respect to the lower track structure 501 by the swing motor 3c. A swing post 503 is mounted on a front portion of the upper swing structure, and the front work implement 504 is vertically movably attached to the swing post 503. The swing post 503 is horizontally angularly movable with respect to the upper swing structure 502 by the swing cylinder 3e as it extends and contracts. The boom 511, the arm 512, and the bucket 513 of the front work implement 504 are vertically angularly movable by the boom cylinder 3a, the arm cylinder 3b, and the bucket cylinder 3d as they extend and contract. The lower track structure 501 includes a central frame 505 to which there is attached a blade 506 that is vertically movable by the blade cylinder 3h as it extends and contracts. The lower track structure 501 travels when left and right crawler belts thereof are actuated by the track motors 3f and 3g as they rotate.

An operation room 508 is installed on the upper swing structure 502. The operation room 508 houses therein the operator seat 521, the operation devices 60a through 60d for the boom cylinder 3a, the arm cylinder 3b, the bucket cylinder 3d, and the swing motor 3c, the operation device 60e for the swing cylinder 3e, the operation device 60h for the blade cylinder 3h, the operation devices 60f and 60g for the track motors 3f and 3g, and the gate lock lever 24.

˜Operation˜

Operation of the present embodiment will be described below with reference to FIGS. 1 through 6.

First, the hydraulic fluid delivered from the fixed-displacement pilot pump 30 that is driven by the prime mover 1 is supplied to the hydraulic fluid supply line 31a. The pilot relief valve 32, which is connected to the hydraulic fluid supply line 31a, generates the pilot primary pressure Ppi0 in the hydraulic fluid supply line 31a. When the gate lock lever 24 is operated to shift the gate lock valve 100 from the illustrated position, the pilot primary pressure Ppi0 is supplied to the hydraulic fluid supply line 31b.

(a) When the Operation Levers of all the Operation Devices are Neutral.

As all the operation levers of the operation devices 60a through 60h are neutral, all the directional control valves 6a, 6b, 6c, 6d, 6e, 6f, 6g, 6h, 6i, and 6j are in their neutral positions. The hydraulic fluid delivered from the variable-displacement main pumps 102, 202, and 302 flows through the hydraulic fluid supply lines 105, 205, and 305 and neutral circuits (central bypass hydraulic lines) of the directional control valves 6a, 6b, 6c, 6d, 6e, 6f, 6g, 6h, 6i, and 6j, and is discharged to the tank. Therefore, the pressures P1, P2, and P3 in the hydraulic fluid supply lines 105, 205, and 305 are kept low (as a tank pressure).

The pressure P3 in the hydraulic fluid supply line 305 is introduced through the hydraulic line 305a to the operation drive section 11h of the tilting control valve 11b and also to the variable pressure reducing valve 12. Since the pressure P3 is low, the pressure introduced to the operation drive section 11h and the pressure receiving section 12b of the variable pressure reducing valve 12 is also kept low.

Similarly, the pressures P1 and P2 in the hydraulic fluid supply lines 105 and 205 are introduced respectively to the operation drive sections 10h and 10i of the tilting control valve 10b. Since the pressures P1 and P2 are low, the pressures introduced to the operation drive sections 10h and 10i are also kept low.

As all the operation levers of the operation devices 60a through 60h are neutral, the boom raising operation pressure and the swing operation pressure that are detected by the pressure sensors 41 and 42 are the tank pressure.

As indicated by the function block diagram of the controller 50 illustrated in FIG. 4 and the characteristics of the tables 50a and 50b illustrated in FIGS. 5A and 5B, when the boom raising operation pressure and the swing operation pressure are the tank pressure, the gain Gain_bmu according to boom raising operation and the gain Gain_sw according to swing operation are 0, and the correction value ΔP3m computed by the multiplier 50d of the controller 50 is 0. Therefore, the current command 115 is also 0, and the output current supplied to the proportional solenoid valve 15 is 0.

The output pressure ΔP3 of the proportional solenoid valve 15 is introduced as a correction value for the horsepower control starting pressure P3a (second allowable torque) for the second regulator 11 to the second operation drive section 11i of the tilting control valve 11b, and also introduced as a correction value for the limiting pressure P3b to the pressure receiving section 12b of the variable pressure reducing valve 12. Since the output current based on the current command 115 given to the proportional solenoid valve 15 is 0, the output pressure ΔP3 of the proportional solenoid valve 15 is the tank pressure.

Consequently, because the tank pressure is introduced to the pressure receiving section 12b of the variable pressure reducing valve 12, the set pressure of the variable pressure reducing valve 12 is of the value P3bmax determined by the spring 12a, so that the pressure P3 in the hydraulic line 305a that is kept low as described above is introduced as it is to the hydraulic line 305b.

Inasmuch as the operation drive sections 10h, 10i, and 10j of the tilting control valve 10b are kept low in pressure, the spool 10g of the tilting control valve 10b is shifted to the right in FIG. 1 by the spring 10f, draining the hydraulic fluid from the larger-diameter pressure receiving chamber 10a of the differential piston 10e to the tank.

As the larger-diameter pressure receiving chamber 10a of the differential piston 10e is kept under the tank pressure, the differential piston 10e is shifted to the left in FIG. 1, keeping the displacement volumes of the variable-displacement main pumps 102 and 202 maximum.

Inasmuch as the operation drive sections 11h and 11i of the tilting control valve 11b are kept low in pressure, the spool 11g of the tilting control valve 11b is shifted to the right in FIG. 1 by the spring 11f, draining the hydraulic fluid from the larger-diameter pressure receiving chamber 11a of the differential piston 11e to the tank.

As the larger-diameter pressure receiving chamber 11a of the differential piston 11e is kept under the tank pressure, the differential piston 11e is shifted to the left in FIG. 1, keeping the displacement volume of the variable-displacement main pump 302 maximum.

(b) When a Boom Raising Operation is Performed.

The operation pressure a1 for boom raising is delivered from the boom raising pilot valve of the boom operation device 60a.

The operation pressure a1 for boom raising shifts the directional control valve 6a to the right in FIG. 1 and also shifts the directional control valve 6i to the right in FIG. 1.

The hydraulic fluid delivered from the variable-displacement main pump 102 is supplied through the hydraulic fluid supply line 105 and the directional control valve 6a, and the hydraulic fluid delivered from the variable-displacement main pump 202 is supplied through the hydraulic fluid supply line 205 and the directional control valve 6i, to the bottom-side compartment of the boom cylinder 3a, extending the rod of the boom cylinder 3a.

The pressures P1 and P2 in the hydraulic fluid supply lines 105 and 205 of the variable-displacement main pumps 102 and 202 vary depending on the magnitude of the load on the boom cylinder 3a.

On the other hand, the operation devices 60c, 60e, and 60h for operating the actuators 3c, 3e, and 3h that are driven by the variable-displacement main pump 302 are not operated. Therefore, as with the case (a) described above, the pressure P3 in the hydraulic fluid supply line 305 of the variable-displacement main pump 302 is kept low.

The pressure P3 in the hydraulic fluid supply line 305 of the variable-displacement main pump 302 is introduced through the hydraulic line 305a to the variable pressure reducing valve 12. When only the boom raising operation is performed, as described above, the pressure P3 is kept low.

The boom raising operation pressure and the swing operation pressure are detected respectively by the pressure sensors 41 and 42 and inputted to the controller 50.

The controller 50 computes the correction value ΔP3m for the horsepower control starting pressure P3a from the pressures detected respectively by the pressure sensors 41 and 42. When only the boom raising operation is performed, the gain Gain_sw according to swing operation is Gain_sw=0 from the characteristics of the table 50b illustrated in FIG. 5B, and the correction value ΔP3m is 0. Therefore, the current command 115 is also 0, and the output pressure ΔP3 of the proportional solenoid valve 15 is the tank pressure.

At this time, the set pressure (limiting pressure) of the variable pressure reducing valve 12 is of the value P3bmax determined by the spring 12a, as with the case (a) described above. Because the pressure P3 in the hydraulic line 305a that is kept low is introduced to the variable pressure reducing valve 12 as described above, the output pressure P3′ of the variable pressure reducing valve 12 is P3′ ≈0<P3bmax, and the pressure P3′ that is kept low is introduced to the first operation drive section 10j of the tilting control valve 10b.

The pressures P1 and P2 in the respective hydraulic fluid supply lines 105 and 205 are introduced respectively to the operation drive sections 10h and 10i of the tilting control valve 10b.

As described above, the pressures P1 and P2 in the hydraulic fluid supply lines 105 and 205 vary depending on the load on the boom cylinder 3a. When the sum of the pressures P1 and P2 is smaller than the horsepower control starting pressure P3amax for securing the maximum allowable torque of the second regulator 11 that is determined by the spring 10f of the tilting control valve 10b, the spool 10g of the tilting control valve 10b is shifted to the right in FIG. 1 by the spring 10f, draining the hydraulic fluid from the larger-diameter pressure receiving chamber 10a of the differential piston 10e to the tank. The differential piston is shifted to the left in FIG. 1, increasing the tilt of the variable-displacement main pumps 102 and 202.

When the sum of the pressures P1 and P2 is larger than the horsepower control starting pressure P3amax for securing the maximum allowable torque of the second regulator 11 that is determined by the spring 10f of the tilting control valve 10b, the force tending to push the spool 10g to the left overcomes the force of the spring 10f, moving the spool 10g to the left in FIG. 1, thereby guiding the hydraulic fluid from the hydraulic line 20a to the larger-diameter pressure receiving chamber 10a. Since the pressure in the larger-diameter pressure receiving chamber 10a of the differential piston 10e and the pressure in the smaller-diameter pressure receiving chamber 10d thereof become equal to each other, the differential piston 10e is moved to the right in FIG. 1 due to the difference between the pressure receiving areas thereof, reducing the tilt of the variable-displacement main pumps 102 and 202. When the differential piston 10e is shifted to the right in FIG. 1, the tilting control valve 10b has its outer peripheral portion moved to the right in FIG. 1 in ganged relation to the differential piston 10e. When the pressure of the operation drive sections 10h and 10i and the force of the spring 10f are brought into equilibrium, the opening of the spool 10g of the tilting control valve 10b is closed again, stopping the differential piston 10e against movement.

In this manner, the tilting control valve 10b and the differential piston 10e operate for the first regulator 10 to control the flow rates of the hydraulic fluid delivered from the variable-displacement main pumps 102 and 202 such that the sum of the torques consumed by the variable-displacement main pumps 102 and 202 does not exceed the value predetermined by the spring 10f (maximum allowable torque T12allw_max), i.e., for the first regulator 10 to perform so-called horsepower control.

On the other hand, as both of the operation drive sections 11h and 11i of the tilting control valve 11b of the second regulator 11 are kept under the low pressure, the spool 11g of the tilting control valve 11b is shifted to the right in FIG. 1 by the spring 11f, draining the hydraulic fluid from the larger-diameter pressure receiving chamber 11a of the differential piston 11e to the tank.

Since the larger-diameter pressure receiving chamber 11a of the differential piston 11e is kept under the tank pressure, the differential piston 11e is shifted to the left in FIG. 1, keeping the displacement volume of the variable-displacement main pump 302 maximum.

(c) When a Swing Operation is Performed.

The swing operation pressure ch (higher one of the operation pressures c1 and c2) is delivered from the pilot valve of the swing operation device 60c. Under the swing operation pressure ch, the directional control valve 6c is shifted to the left or the right in FIG. 1.

The hydraulic fluid delivered from the variable-displacement main pump 302 is supplied through the hydraulic fluid supply line 305 and the directional control valve 6c to the swing motor 3c, rotating the swing motor 3c. The pressure P3 in the hydraulic fluid supply line 305 of the variable-displacement main pump 302 varies depending on the magnitude of the load on the swing motor 3c.

On the other hand, since neither one of the operation levers of the operation devices 60a, 60b, 60d, 60f, and 60g for operating the actuators 3a, 3b, 3d, 3f, and 3g that are driven by the variable-displacement main pumps 102 and 202 is operated, the hydraulic fluid delivered from the variable-displacement main pumps 102 and 202 flows through the hydraulic fluid supply lines 105 and 205 and the directional control valves 6a, 6b, 6d, 6f, and 6g, and is discharged to the tank, as with the case (a) described above. The pressures P1 and P2 in the hydraulic fluid supply lines 105 and 205 are kept low.

The pressure P3 in the hydraulic fluid supply line 305 of the variable-displacement main pump 302 is introduced through the hydraulic line 305a to the variable pressure reducing valve 12. The boom raising operation pressure and the swing operation pressure are detected respectively by the pressure sensors 41 and 42 and inputted to the controller 50.

The controller 50 computes the correction value ΔP3m for the horsepower control starting pressure P3a from the pressures detected respectively by the pressure sensors 41 and 42. When only the swing operation is performed, the gain Gain_bmu according to boom raising operation is Gain_bmu=0 from the characteristics of the table 50b illustrated in FIG. 5A, and the correction value ΔP3m is 0. Therefore, the current command 115 is also 0, and the output pressure ΔP3 of the proportional solenoid valve 15 is the tank pressure.

At this time, the horsepower control starting pressure of the second regulator 11 is of the value P3amax determined by the spring 11f. When the pressure P3 in the hydraulic line 305a introduced to the operation drive section 11h is higher than the horsepower control starting pressure P3amax, the force tending to push the spool 11g to the left overcomes the force of the spring 11f, moving the spool 11g to the left in FIG. 1, thereby guiding the hydraulic fluid from the hydraulic line 305a to the larger-diameter pressure receiving chamber 11a. Since the pressure in the larger-diameter pressure receiving chamber 11a of the differential piston 11e and the pressure in the smaller-diameter pressure receiving chamber 11d thereof become equal to each other, the differential piston 11e is moved to the right in FIG. 1 due to the difference between the pressure receiving areas thereof, reducing the tilt of the variable-displacement main pump 302. When the differential piston 11e is shifted to the right in FIG. 1, the tilting control valve 11b has its outer peripheral portion moved to the right in FIG. 1 in ganged relation to the differential piston 11e. When the pressure of the operation drive section 11h and the force of the spring 11f are brought into equilibrium, the opening of the spool 11g of the tilting control valve 11b is closed again, stopping the differential piston 11e against movement.

With the differential piston 11e operating in this manner, the displacement volume q3 of the main pump 302 varies as indicated by the solid-line curve in FIG. 8. The variable-displacement main pump 302 performs so-called horsepower control for controlling the flow rate of the hydraulic fluid delivered thereby such that the torque does not exceed the torque value predetermined by the spring 11f (maximum allowable torque T3allw_max).

As the output pressure ΔP3 of the proportional solenoid valve 15 is the tank pressure, the set pressure (limiting pressure) of the variable pressure reducing valve 12 is of the value P3bmax determined by the spring 12a, as with the cases (a) and (b) described above. Therefore, the output pressure P3′ of the variable pressure reducing valve 12 is of the characteristics in the case of Gain_bmu=0, as illustrated in FIG. 6B. When the pressure P3 in the hydraulic line 305a is in the range of 0<P3<P3bmax, the output pressure P3′ is the same as the pressure P3 in the hydraulic line 305a. When the pressure P3 is in the range of P3 P3bmax, the pressure P3 in the hydraulic line 305a is limited to the set pressure P3bmax.

Since the output pressure P3′ of the variable pressure reducing valve 12 is introduced to the first operation drive section 10j of the tilting control valve 10b, the allowable torque of the variable-displacement main pumps 102 and 202 is of the characteristics in the case of Gain_bmu=0 in FIG. 7C, and is of a value obtained by subtracting the torque T3 consumed by the variable-displacement main pump 302 illustrated in FIG. 7B from the maximum allowable torque T12allw_max of the variable-displacement main pumps 102 and 202.

The variable-displacement main pumps 102 and 202 deliver the hydraulic fluid such that the torque consumed thereby will be equal or smaller than the allowable torque T12allw_max. When only a swing operation is performed as described above, both of the hydraulic fluid supply lines 105 and 205 of the variable-displacement main pumps 102 and 202 are held under the low pressure, so that the variable-displacement main pumps 102 and 202 keep their maximum delivery flow rates.

(d) When a Swing Operation and a Boom Raising Operation are Performed Simultaneously.

The boom raising pilot valve of the operation device 60a for the boom delivers the boom raising operation pressure a1, and the pilot valve of the operation device 60c for swinging delivers the swing operation pressure ch (higher one of the operation pressures c1 and c2).

Under the boom raising operation pressure a1, the directional control valve 6a is shifted to the right in FIG. 1, and the directional control valve 6i is shifted to the right in FIG. 1. Under the swing operation pressure ch, the directional control valve 6c is shifted to the left or the right in FIG. 1.

The hydraulic fluid delivered from the variable-displacement main pump 102 is supplied through the hydraulic fluid supply line 105 and the directional control valve 6a, and the hydraulic fluid delivered from the variable-displacement main pump 202 is supplied through the hydraulic fluid supply line 205 and the directional control valve 6i, to the bottom-side compartment of the boom cylinder 3a, extending the rod of the boom cylinder 3a.

The pressures P1 and P2 in the hydraulic fluid supply lines 105 and 205 of the variable-displacement main pumps 102 and 202 vary depending on the magnitude of the load on the boom cylinder 3a.

The hydraulic fluid delivered from the variable-displacement main pump 302 is supplied through the hydraulic fluid supply line 305 and the directional control valve 6c to the swing motor 3c, rotating the swing motor 3c.

The pressure P3 in the hydraulic fluid supply line 305 of the variable-displacement main pump 302 varies depending on the magnitude of the load on the swing motor 3c.

The boom raising operation pressure and the swing operation pressure are detected respectively by the pressure sensors 41 and 42 and inputted to the controller 50.

The controller 50 computes the correction value ΔP3m for the horsepower control starting pressure P3a from the pressures detected respectively by the pressure sensors 41 and 42. When the boom raising operation and the swing operation are performed simultaneously, the boom raising operation gain Gain_bmu is Gain_bmu=1 and the swing operation gain Gain_sw is of a value between 0 and 0.5 depending on the swing operation pressure, from the characteristics of the tables 50a and 50b illustrated in FIG. 5. The correction value ΔP3m is calculated as a value obtained by multiplying the horsepower control starting pressure P3amax of the variable-displacement main pump 302 at the time the output pressure of the proportional solenoid valve 15 is 0 by Gain_bmu and Gain_sw. The correction value ΔP3m is converted into the current command 115, and a corresponding current is output to the proportional solenoid valve 15. The proportional solenoid valve 15 generates and delivers an output pressure ΔP3 corresponding to the correction value ΔP3m.

In other words, when the boom raising and the swinging are performed simultaneously, the output pressure ΔP3 of the proportional solenoid valve 15 is represented as ΔP3=P3amax×Gain_bmu×Gain_sw. Since the boom raising operation gain Gain_bmu is Gain_bmu=1 at all times, the output pressure ΔP3 is represented as ΔP3=P3amax×Gain_sw. Therefore, as illustrated in FIG. 6A, the output pressure ΔP3 is small when the swing operation pressure is small, and increases as the swing operation pressure increases.

The output pressure ΔP3 of the proportional solenoid valve 15 is introduced to the pressure receiving section 12b of the variable pressure reducing valve 12, reducing the set pressure of the variable pressure reducing valve 12 by the introduced pressure. As illustrated in FIG. 6B, the larger the swing operation gain Gain_sw, the output pressure P3′ of the variable pressure reducing valve 12 is limited to a smaller value. When Gain_sw=0.5, the output pressure P3′ of the variable pressure reducing valve 12 is limited to 0.5 times the set pressure P3bmax determined by the spring 12a.

Furthermore, the output pressure ΔP3 of the proportional solenoid valve 15 is introduced to the second operation drive section 11i of the tilting control valve 11b in the second regulator 11 of the variable-displacement main pump 302. The output pressure P3′ of the variable pressure reducing valve 12 is introduced to the first operation drive section 10j of the tilting control valve 10b in the first regulator 10 of the variable-displacement main pumps 102 and 202.

As described above, since the second regulator 11 controls the displacement volume of the variable-displacement main pump 302 to bring the force of the spring 11f of the tilting control valve 11b and the pressures acting on the operation drive sections 11h and 11i into equilibrium, the output pressure ΔP3 of the proportional solenoid valve 15 that is introduced to the second operation drive section 11i acts in a direction to reduce the allowable torque T3allw of the variable-displacement main pump 302.

As illustrated in FIG. 7A, the larger the swing operation gain Gain_sw, the smaller the allowable torque T3allw of the variable-displacement main pump 302. When Gain_sw=0.5, the allowable torque T3allw of the variable-displacement main pump 302 is limited to 0.5 times the maximum allowable torque T3allw_max determined by the spring 11f.

At this time, the displacement volume q3 of the variable-displacement main pump 302 varies as indicated by the broken-line curve in FIG. 8. As illustrated in FIG. 7B, the larger the swing operation gain Gain_sw, the torque T3 actually consumed by the main pump 302 is limited to a smaller value. When Gain_sw=0.5, the torque T3 actually consumed by the main pump 302 is limited to 0.5 times the maximum torque T3max.

Similarly, the first regulator 10 controls the displacement volumes of the variable-displacement main pumps 102 and 202 to bring the force of the spring 10f of the tilting control valve 10b and the pressures acting on the operation drive sections 10h, 10i, and 10j into equilibrium. The first operation drive section 10j is originally provided to convert the torque of the variable-displacement main pump 302 into a pressure and feed back the pressure. By limiting the delivery pressure of the variable-displacement main pump 302 that is introduced to the first operation drive section 10j, with the variable pressure reducing valve 12, the allowable torque T12allw is reduced by the torque actually consumed by the variable-displacement main pump 302.

As described above, since the larger the swing operation torque Gain_sw, the torque T3 consumed by the variable-displacement main pump 302 is limited by a larger value, the allowable torque T12allw of the variable-displacement main pumps 102 and 202 is accordingly limited by a larger value, as illustrated in FIG. 7C.

When Gain_sw=0.5, in a manner corresponding to the allowable torque of the main pump 302 being reduced to T3allw_max×0.5 (or the torque consumed by the main pump 302 being reduced to T3max×0.5), the allowable torque T12allw of the variable-displacement main pumps 102 and 202 is reduced to a value obtained by subtracting one half of the maximum allowable torque T3allw_max of the main pump 302 from the maximum allowable torque T12allw_max (T12allw_max−T3allw_max×0.5) or a value obtained by subtracting one half of the maximum torque T3max consumed by the main pump 302 from the maximum allowable torque T12allw_max (T12allw_max−T3max×0.5).

In this fashion, when the swing motor 3c and the boom cylinder 3a are driven simultaneously, the allowable torque T3allw of the main pump 302 that drives the swing motor 3c is corrected so as to be reduced, making it possible to increase the allowable torque T12allw of the main pumps 102 and 202 that drive the boom cylinder 3a by the reduction in the torque consumed by the main pump 302 that drives the swing motor 3c. Consequently, even if the set torque T3allw_max of the main pump 302 that drives the swing motor 3c is originally large, a distribution of torques between the main pumps 102 and 202 and the main pump 302 is appropriately adjusted regardless of the respective torque settings T12allw_max and T3allw_max of the main pumps 102 and 202 and the main pump 302. When the boom raising and the swinging are performed simultaneously, the boom raising can be performed speedily, thereby realizing excellent combined operability.

If the load on the swing motor 3c is small and the delivery pressure P3 of the main pump 302 is lower than the set pressure of the variable pressure reducing valve 12, the output pressure P3′ of the variable pressure reducing valve 12 is P3′=P3, and the torque actually consumed by the main pump 302 is accurately fed back to the main pumps 102 and 202, so that the allowable torque T12allw of the main pumps 102 and 202 does not be limited unnecessarily. This also allows the boom raising to be performed speedily, thereby realizing excellent combined operability and effective use of the output torque of the prime mover 1 when the boom raising and the swinging are performed simultaneously.

Moreover, when the boom raising and the swinging are performed simultaneously, the controller 50 calculates the correction value ΔP3m as a value that increases as the swing operation pressure ch increases. Therefore, when the swing operation is carried out after the boom raising operation, switching to simultaneously performing the boom raising and the swinging, the allowable torque of the main pump 302 and the allowable torque of the main pumps 102 and 202 are continuously adjusted depending on the swing operation amount, making it possible to perform a smooth swing and boom raising operation for excellent combined operability.

˜Advantages˜

The present embodiment offers the following advantages:

1. Since the flow rate of the hydraulic fluid delivered from the main pump 302 is controlled by only the delivery pressure of the main pump 302, the hydraulic fluid delivered from the main pump 302 flows at a stable flow rate without being affected by variations in the flow rates of the hydraulic fluid delivered from the main pumps 102 and 202. The swing motor 3c can thus be driven at a stable rotational speed.

2. The output pressure P3′ of the variable pressure reducing valve 12 (first valve device) is fed back as the torque actually consumed by the main pump 302 to the first operation drive section 10j of the first regulator 10, and the horsepower control starting pressure for securing the allowable torque T12allw of the main pumps 102 and 202 is corrected so as to be reduced by the first output pressure P3′. Consequently, it is possible to perform so-called horsepower control for controlling the sum of the torques consumed by the main pump 302 that drive the swing motor and the main pumps 102 and 202 that drive the boom cylinder so as not to exceed the predetermined value T12allw_max.

3. When the swing motor 3c and the boom cylinder 3a are driven simultaneously, the allowable torque T3allw of the main pump 302 that drives the swing motor 3c is corrected so as to be reduced, making it possible to increase the allowable torque T12allw of the main pumps 102 and 202 that drive the boom cylinder 3a by the reduction in the torque consumed by the main pump 302 that drives the swing motor 3c. Consequently, even if the set torque T3allw_max of the main pump 302 that drives the swing motor 3c is originally large, a distribution of torques between the main pumps 102 and 202 and the main pump 302 is appropriately adjusted regardless of the respective torque settings T12allw_max and T3allw_max of the main pumps 102 and 202 and the main pump 302. When the boom raising and the swinging are performed simultaneously, the boom raising can be performed speedily, thereby realizing excellent combined operability.

4. When the swing motor 3c and the boom cylinder 3a are driven simultaneously, as described above, since the allowable torque T3allw of the main pump 302 that drives the swing motor 3c is corrected so as to be reduced, the maximum allowable torque T3allw_max of the main pump 302 can be set freely without being limited by a torque distribution at the time of a combined swing and boom raising operation. Thus, an optimum swing torque is obtained in an independent swing operation for increased swing operability.

5. When the load on the swing motor 3c is small and the delivery pressure P3 of the main pump 302 is lower than the set pressure of the variable pressure reducing valve 12, the output pressure P3′ of the variable pressure reducing valve 12 is P3′=P3, and the torque actually consumed by the main pump 302 is accurately fed back to the main pumps 102 and 202, so that the allowable torque T12allw of the main pumps 102 and 202 does not be limited unnecessarily. This also allows the boom raising to be performed speedily, thereby realizing excellent combined operability and effective use of the output torque of the prime mover 1 when the boom raising and the swinging are performed simultaneously.

6. Moreover, when the boom raising and the swinging are performed simultaneously, the controller 50 calculates the correction value ΔP3m as a value that increases as the swing operation pressure ch increases. Therefore, when the swing operation is carried out after the boom raising operation, switching to simultaneously performing the boom raising and the swinging, the allowable torque of the main pump 302 and the allowable torque of the main pumps 102 and 202 are continuously adjusted depending on the swing operation amount, making it possible to perform a smooth swing and boom raising operation for excellent combined operability.

7. The output pressure ΔP3 of the proportional solenoid valve 15 is used in both a circuit portion for limiting the allowable torque T3allw of the main pump 302 that drives the swing motor and a circuit portion for feeding back the torque consumed by the main pump 302 that drives the swing motor to the main pumps 102 and 202 that drive the boom cylinder. Therefore, even in the event of an operation failure of the controller 50 that computes the correction value and the proportional solenoid valve 15 that outputs the hydraulic first correction value, the sum of the torques of the main pumps 102 and 202 for driving the boom cylinder and the main pump 302 for driving the swing motor does not exceed the predetermined value T12allw_max, so that the prime mover 1 is reliably prevented from stalling.

### Second Embodiment

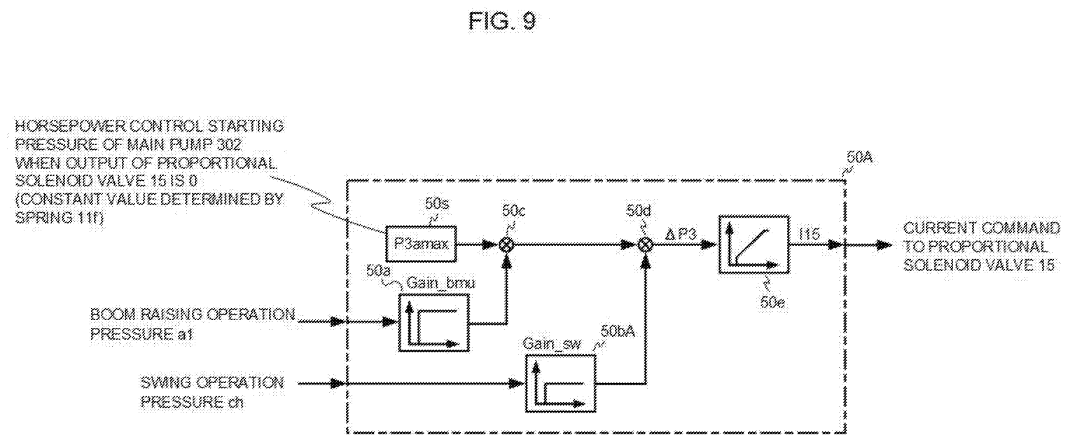

A hydraulic drive system for a construction machine according to a second embodiment of the present invention will be described below with reference to FIGS. 9 through 12C. The circuit arrangement of the hydraulic drive system according to the present embodiment is the same as that of the first embodiment illustrated in FIG. 1. According to the present embodiment, the controller 50 is replaced with a controller 50A.

FIG. 9 is a functional block diagram illustrating a function regarding torque feedback control that is performed by a CPU 50a of the controller 50A according to the second embodiment of the present invention.

In FIG. 9, the function of the CPU 50a of the controller 50A is the same as the controller 50 according to the first embodiment except that the swing operation correction table 50b has changed to a swing operation correction table 50bA.

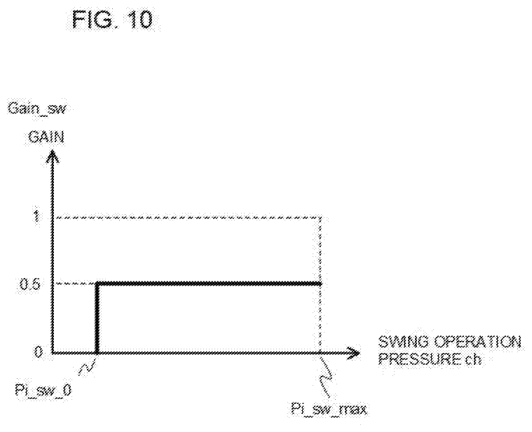

FIG. 10 is a diagram illustrating details of the swing operation correction table 50bA.

In FIG. 10, the table 50b has set therein characteristics in which when the swing operation pressure ch is higher than a minimum pressure Pi_sw_0 in excess of a dead zone, a gain Gain_sw according to swing operation increases stepwise from 0 to 0.5.

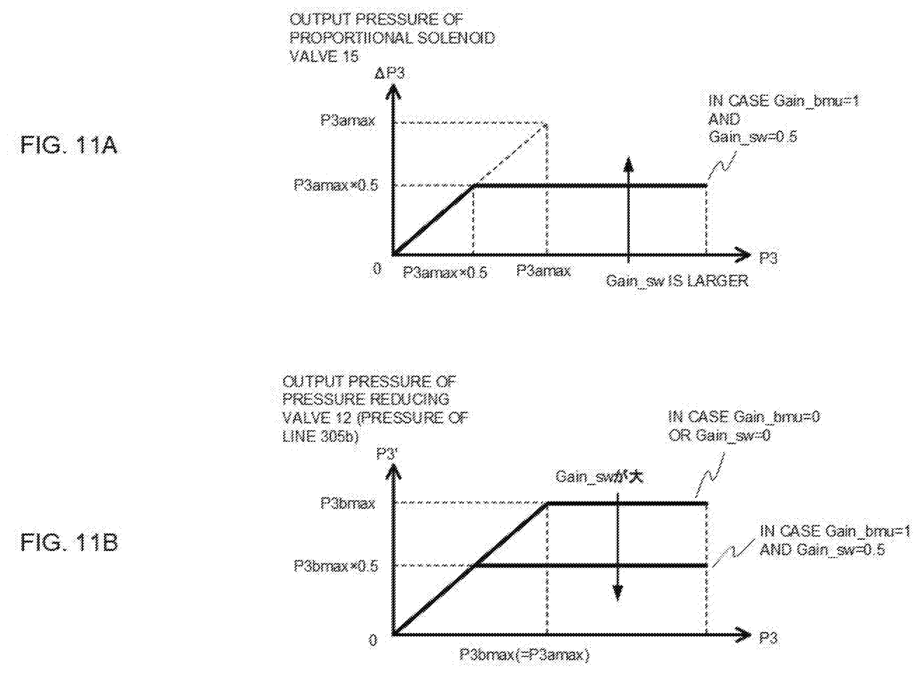

A torque feedback behavior in a combined operation for swinging and boom raising according to the present embodiment will be described below with reference to FIGS. 11A and 11B.

FIG. 11A is a diagram illustrating changes in the output pressure ΔP3 of the proportional solenoid valve 15 controlled by the controller 50A. As illustrated in FIG. 11A, when a combined operation for swinging and boom raising is performed and the gain Gain_bmu according to boom raising operation is Gain_bmu=1, since the gain Gain_sw according to swing operation is 0.5, the output pressure ΔP3 is limited to the horsepower control starting pressure P3amax×0.5 (one half of the horsepower control starting pressure P3amax) regardless of the magnitude of the swing operation pressure.

FIG. 11B is a diagram illustrating output characteristics of the variable pressure reducing valve 12. Since the output pressure ΔP3 of the proportional solenoid valve 15 illustrated in FIG. 11A is introduced to the pressure receiving section 12b of the variable pressure reducing valve 12, as described above, when a combined operation for swinging and boom raising is performed and the gain Gain_bmu according to boom raising operation is Gain_bmu=1, the set pressure P3b of the variable pressure reducing valve 12 immediately becomes one half of the set pressure P3bmax of the spring 12a. Therefore, when the pressure P3 in the hydraulic fluid supply line 305 (delivery pressure of the main pump 302) is higher than the limiting pressure P3b of the variable pressure reducing valve 12, the output pressure P3′ of the variable pressure reducing valve 12 is limited to one half of the set pressure P3bmax of the spring 12a regardless of the magnitude of the swing operation pressure.

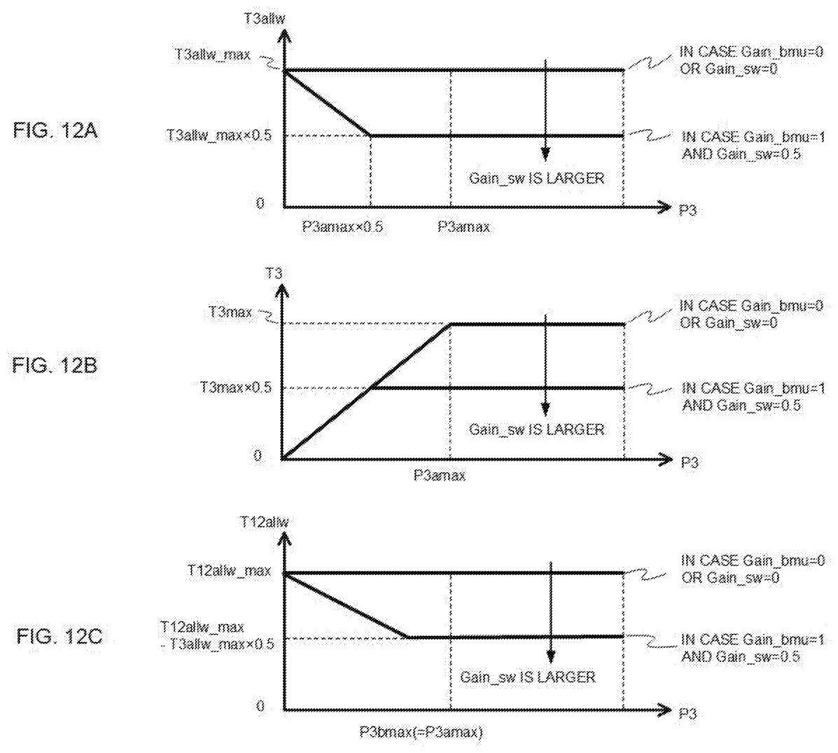

Characteristics of allowable torques of the variable-displacement main pumps 102, 202, and 302 and characteristics of the torque consumed by the main pump 302 will be described below with reference to FIGS. 12A, 12B, and 12C.

FIG. 12A is a diagram illustrating characteristics of the allowable torque T3allw of the variable-displacement main pump 302. In FIG. 12A, when a combined operation for swinging and boom raising is performed and the gain Gain_bmu according to boom raising operation is Gain_bmu=1, the allowable torque T3allw of the main pump 302 becomes one half of the maximum allowable torque T3allw_max (T3allw_max×0.5).

FIG. 12B is a diagram illustrating characteristics of the torque T3 that is actually consumed by the variable-displacement main pump 302. In FIG. 12B, when a combined operation for swinging and boom raising is performed and the gain Gain_bmu according to boom raising operation is Gain_bmu=1, since the allowable torque T3allw of the main pump 302 becomes one half of the maximum allowable torque T3allw_max, the torque T3 actually consumed by the main pump 302 becomes one half of the maximum consumed torque T3max (T3max×0.5).

FIG. 12C is a diagram illustrating characteristics of the allowable torque T12allw of the variable-displacement main pumps 102 and 202. In FIG. 12C, when a combined operation for swinging and boom raising is performed and the gain Gain_bmu according to boom raising operation is Gain_bmu=1, in a manner corresponding to the allowable torque T3allw_max×0.5 of the main pump 302 (or the torque T3max×0.5 consumed by the main pump 302) being reduced, the allowable torque T12allw of the main pumps 102 and 202 is reduced to a value obtained by subtracting one half of the maximum allowable torque T3allw_max of the main pump 302 from the maximum allowable torque T12allw_max (T12allw_max−T3allw_max×0.5) or a value obtained by subtracting one half of the maximum torque T3max consumed by the main pump 302 from the maximum allowable torque T12allw_max (T12allw_max−T3max×0.5).

˜Advantages˜

The present embodiment arranged as described above offers the advantages other than the advantage 6, among the advantages 1 through 7 described in the first embodiment.

### Third Embodiment

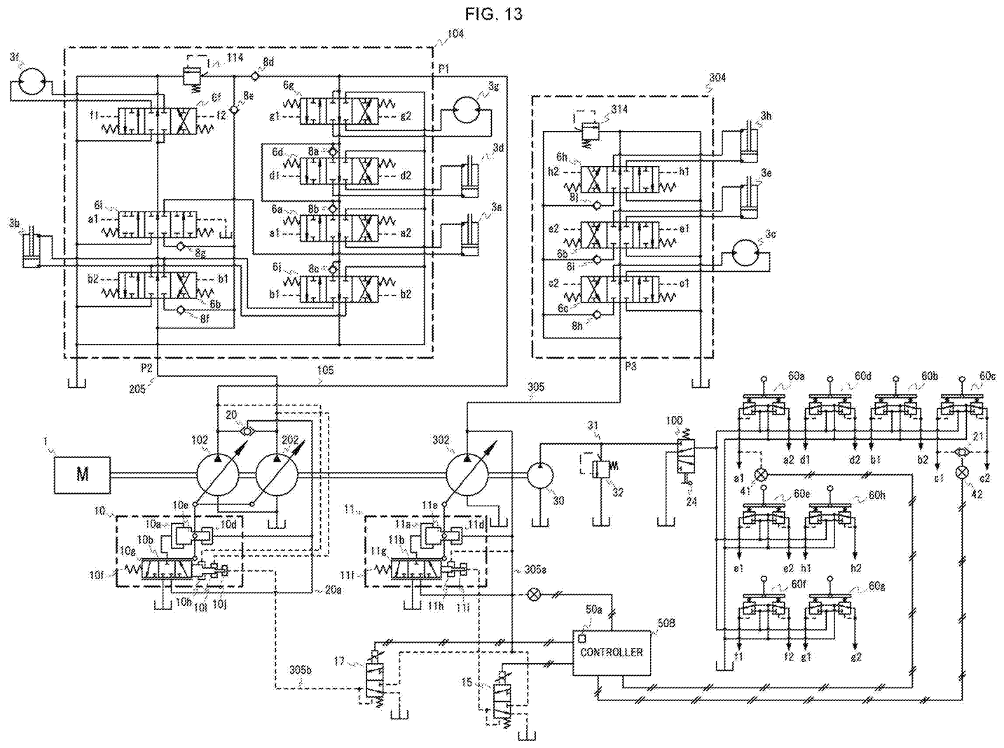

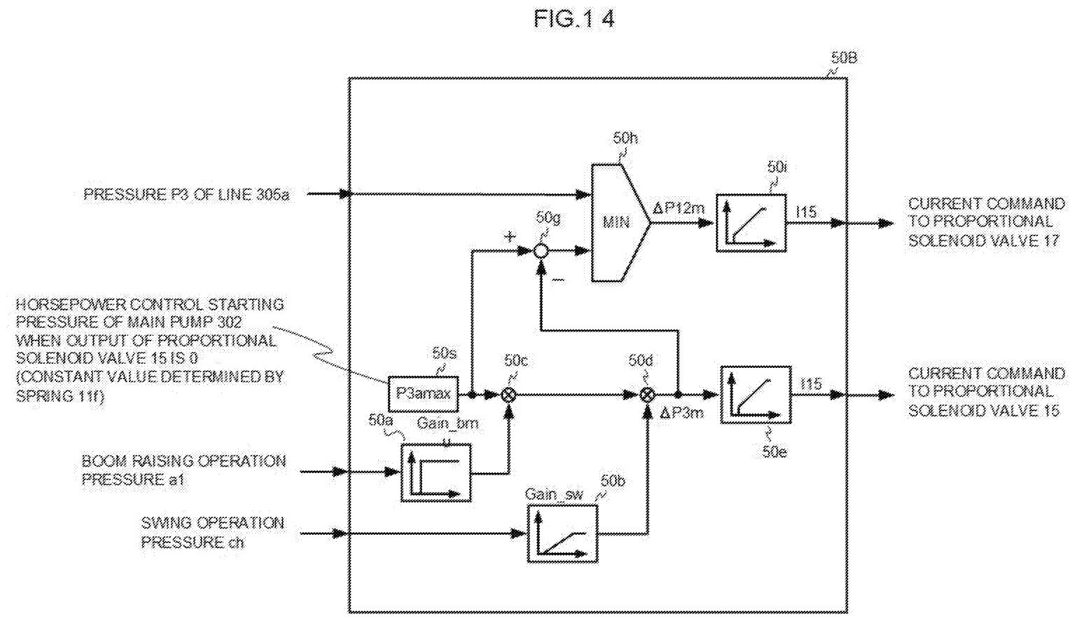

A hydraulic drive system for a construction machine according to a third embodiment of the present invention will be described below with reference to FIGS. 13 and 14.

FIG. 13 is a diagram illustrating the configuration of the hydraulic drive system for the construction machine according to the third embodiment of the present invention.

In FIG. 13, the hydraulic drive system according to the present embodiment includes a proportional solenoid valve 17 instead of the variable pressure reducing valve 12. The hydraulic drive system includes a pressure sensor 43 for detecting the pressure P3 in the hydraulic line 305a (delivery pressure of the main pump 302) and outputs from the pressure sensors 41, 42, and 43 are introduced to a controller 50B, and an output from the controller 50B is introduced to the proportional solenoid valve 15 and the proportional solenoid valve 17.

FIG. 14 is a functional block diagram illustrating a function regarding torque feedback control that is performed by a CPU 50a of the controller 50B according to the present embodiment.

In FIG. 14, the CPU 50A of the controller 50B has, in addition to the setting block 50s, the boom raising determining table 50a, the swing operation correction table 50b, the multipliers 50c and 50d, and the current command calculating table 50e, functions as a subtractor 50g, a minimum value selector 50h, and a current command calculating table 50i.

As described above, the setting block 50s has set therein a horsepower control starting pressure P3amax for the second regulator 11 (constant value determined by the spring 11f in the second regulator 11). The horsepower control starting pressure P3amax and the correction value ΔP3m computed by the multiplier 50d are input to the subtractor 50g. The subtractor 50g determines a value obtained by subtracting the correction value ΔP3m computed by the multiplier 50d from the horsepower control starting pressure P3amax, as a correction value P3′m. The pressure P3 in the hydraulic line 305a that is detected by the pressure sensor 43 and the horsepower control starting pressure P3amax are input to the minimum value selector 50h, which selects a smaller one of the pressure P3 in the hydraulic line 305a and the horsepower control starting pressure P3amax as a correction value ΔP12m for a horsepower control starting pressure P12a for the first regulator 10.

The correction value ΔP12m computed by the minimum value selector 50h is input to the table 50i, which converts the correction value ΔP12m into a current command 117 for driving the proportional solenoid valve 17. The controller 50B then outputs a corresponding current. The proportional solenoid valve 17 is operated by the output current to generate and output an output pressure ΔP12 corresponding to the correction value ΔP12m. The output pressure ΔP12 from the proportional solenoid valve 17 is introduced as a correction value for the horsepower control starting pressure (first allowable torque) of the first regulator 10 to the first operation drive section 10j of the tilting control valve 10b.

˜Correspondence to the Scope of Claims˜

The proportional solenoid valve 17 serves as a first valve device that generates the first output pressure P3′ to feed back the torque consumed by the main pump 302 to the first regulator 10 based on the delivery pressure of the main pump 302.

The first regulator 10 incudes ae first operation drive section 10j to which the first output pressure P3′ is introduced, and with the first operation drive section 10j, the first regulator 10 corrects the horsepower control starting pressure for securing the first allowable torque T12allw so as to be smaller by the first output pressure P3′ thereby to control the displacement volumes of the main pumps 102 and 202 (first hydraulic pump) such that the sum of the torques consumed by the main pumps 102 and 202 (first hydraulic pump) and the main pump 302 (second hydraulic pump) does not exceed the predetermined value T12allw_max.

The functions of the setting block 50s, the boom raising determining table 50a, the swing operation correction table 50b, and the multipliers 50c and 50d of the controller 50 serve as a controller that when the swing motor 3c and the boom cylinder 3a are driven simultaneously, calculates the correction value ΔP3m for the horsepower control starting pressure for reducing the second allowable torque T3allw of the main pumps 102 and 202 (second hydraulic pump) so as to be smaller than the maximum allowable torque T3allw_max at the time when the swing motor 3c is driven independently.

The proportional solenoid valve 15 serves as a second valve device for generating the second output pressure ΔP3 corresponding to the above correction value ΔP3m calculated by the controller 50.

The second operation drive section 11i is included in the second regulator 11, and to which the second output pressure ΔP3 is introduced for correcting the horsepower control starting pressure P3a for securing the second allowable torque T3allw so as to be smaller by the second output pressure ΔP3.

The functions of the subtractor 50g, the minimum value selector 50h, and the current command calculating table 50i of the controller 50B serve as an output pressure corrector for limiting the output pressure P3′ (first output pressure) of the proportional solenoid valve 17 (first valve device) such that the output pressure P3′ (first output pressure) of the proportional solenoid valve 17 (first valve device) does not exceed the horsepower control starting pressure for securing the second allowable torque corrected by the second operation drive section 11i.

˜Advantages˜

The present embodiment arranged as described above offers the same advantages as the advantages 1 through 6 described in the first embodiment.

˜Others˜

In the above embodiments, the first hydraulic pump for driving the boom cylinder 3a includes the two main pumps 102 and 202. However, the first hydraulic pump may include a single hydraulic pump.

The above embodiments have been described as being applied to a construction machine which is a hydraulic excavator having crawler belts on a lower track structure. However, the construction machine may be of any of other types insofar as they have an upper swing structure and a boom, e.g., a wheeled hydraulic excavator, and those other types offer the same advantages.

### DESCRIPTION OF REFERENCE CHARACTERS

1: Prime mover
102, 202: Variable-displacement main pump (first hydraulic pump)
302: Variable-displacement main pump (second hydraulic pump)
3a to 3h: Actuator
3a: Boom cylinder
3c: Swing motor
6a to 6j: Directional control valve
10: First regulator
11: Second regulator
10a, 11a: Larger-diameter pressure receiving chamber
10b, 11b: Tilting control valve
10d, 11d: Smaller-diameter pressure receiving chamber
10e, 11e: Differential piston
10f, 11f: Spring
10g, 11g: Spool
10h, 10i, 10j, 10k: Operation drive section
10j: First operation drive section
11h, 11i: Operation drive section
11i: Second operation drive section
12: Variable pressure reducing valve (first valve device)
12a: Spring
12b: Pressure receiving section (output pressure corrector)
15: Proportional solenoid valve (second valve device)
17: Proportional solenoid valve (first valve device)
20, 21: Shuttle valve
41, 42: Pressure sensor
50, 50A, 50B: Controller
60a to 60h: Operation device
50g: Subtractor (output pressure corrector)
50h: Minimum value selector (output pressure corrector)
104, 304: Control valve block
T12allw: Allowable torque (first allowable torque)
T12allw_max: Maximum allowable torque (predetermined value)
T3allw: Allowable torque (second allowable torque)
T3allw_max: Maximum allowable torque (predetermined value)
ΔP3m: Correction value
P3′: Output pressure of variable pressure reducing valve 12 (first output pressure)
ΔP3: Output pressure of proportional solenoid valve 15 (second output pressure)
ΔP12m: Correction value

1. A hydraulic drive system for a construction machine, the hydraulic drive system comprising:
a plurality of hydraulic pumps including variable-displacement first and second hydraulic pumps driven by a prime mover;
a plurality of actuators driven by hydraulic fluids delivered from the plurality of hydraulic pumps;
a first regulator to which a delivery pressure of the first hydraulic pump is introduced and that controls a displacement volume of the first hydraulic pump such that a torque consumed by the first hydraulic pump does not exceed a first allowable torque;
a second regulator to which a delivery pressure of the second hydraulic pump is introduced and that controls a displacement volume of the second hydraulic pump such that a torque consumed by the second hydraulic pump does not exceed a second allowable torque; and
a first valve device that generates a first output pressure to feed back the torque consumed by the second hydraulic pump to the first regulator based on the delivery pressure of the second hydraulic pump,
wherein the first regulator includes a first operation drive section to which the first output pressure is introduced and with the first operation drive section, the first regulator corrects a horsepower control starting pressure for securing the first allowable torque so as to be smaller by the first output pressure thereby to control the displacement volume of the first hydraulic pump such that a sum of the torques consumed by the first and second hydraulic pumps does not exceed a predetermined value, and
the plurality of actuators include a boom cylinder for driving a boom of a front work implement and a swing motor for driving an upper swing structure, the boom cylinder being driven by a hydraulic fluid delivered by the first hydraulic pump, and the swing motor being driven by a hydraulic fluid delivered by the second hydraulic pump, and
wherein the hydraulic drive system further comprises:
a controller that, when the swing motor and the boom cylinder are driven simultaneously, calculates a correction value for the horsepower control starting pressure for reducing the second allowable torque of the second hydraulic pump so as to be smaller than a maximum allowable torque at a time when the swing motor is driven independently;
a second valve device for generating a second output pressure corresponding to the correction value calculated by the controller;
a second operation drive section included in the second regulator and to which the second output pressure is introduced for correcting the horsepower control starting pressure for securing the second allowable torque so as to be smaller by the second output pressure; and
an output pressure corrector for limiting the first output pressure of the first valve device such that the first output pressure of the first valve device does not exceed the horsepower control starting pressure for securing the second allowable torque corrected by the second operation drive section.

2. The hydraulic drive system for a construction machine according to claim 1, wherein
the first valve device is a variable pressure reducing valve disposed in a hydraulic line to which the delivery pressure of the second hydraulic pump is introduced for generating the first output pressure,
the second valve device is a proportional solenoid valve operable based on an output current corresponding to the correction value generated by the controller for generating the second output pressure, and
the output pressure corrector comprises a pressure receiving section included in the variable pressure reducing valve and to which the second output pressure of the proportional solenoid valve is introduced for correcting a set pressure of the variable pressure reducing valve so as to be smaller by the second output pressure.

3. The hydraulic drive system for a construction machine according to claim 1, wherein
the controller calculates the correction value for the horsepower control starting pressure by multiplying the horsepower control starting pressure for securing the maximum allowable torque of the second hydraulic pump by a magnification ranging from 0 inclusive to 1 exclusive.

4. The hydraulic drive system for a construction machine according to claim 3, further comprising:
a plurality of directional control valves for controlling flows of the hydraulic fluid supplied to the plurality of actuators; and
a plurality of operation devices for commanding respective drives of the plurality of actuators for shifting the directional control valves corresponding thereto,
wherein the controller inputs an operation signal from one of the plurality of operation devices that commands the drive of the swing motor, and based on the operation signal, calculates the magnification as a value that increases as the operation amount of the operation device increases.

5. The hydraulic drive system for a construction machine according to claim 1, wherein
the output pressure corrector is implemented as a function of the controller,
the controller selects, as the correction value for the horsepower control starting pressure for securing the first allowable torque of the first hydraulic pump, a smaller one of a value obtained by subtracting the correction value from the horsepower control starting pressure for securing the maximum allowable torque of the second regulator when the swing motor is driven independently and a detected value of the delivery pressure of the second hydraulic pump, and outputs a first current corresponding to the selected value,
the controller also outputs a second current corresponding to the correction value for the horsepower control starting pressure for securing the second allowable torque,
the first valve device is a first proportional solenoid valve operable based on the first current output from the controller for generating the first output pressure, and
the second valve device is a second proportional solenoid valve operable based on the second current output from the controller for generating the second output pressure.
